(19) United States
(12) Patent Application Publication
(10) Pub. No.: US 2023/0351516 A1
(43) Pub. Date: Nov. 2, 2023

(54) VISUALIZATIONS AND PREDICTIONS OF ONE OR MORE METRICS ASSOCIATED WITH FINANCIAL HEALTH

(71) Applicant: Mercury Financial Holdings LLC, Wilmington, DE (US)

(72) Inventors: Kenneth Davidson CURRAN, Moorestown, NJ (US); Maria Teresita VICENTE, Lake Wales, FL (US); James F. PETERSON, Cape May, NJ (US); Patrick J. NOLAN, Austin, TX (US); Harish RAGHURAMAN, Austin, TX (US); Simon T. CHAPMAN, Newark, DE (US); Steven T. ADAMS, Townsend, DE (US); Brooke M. DURHAM, Elkton, MD (US); Anand KUMAR, Patna (IN); Madhavi Sruthi KOTHAGUNDU, Cedar Park, TX (US); Sateeshasatya Anvesh Reddy KATAMREDDY, Wilmington, DE (US); Anal R. SHAH, Austin, TX (US)

(73) Assignee: Mercury Financial Holdings LLC, Wilmington, DE (US)

(21) Appl. No.: 18/348,699

(22) Filed: Jul. 7, 2023

Related U.S. Application Data
(62) Division of application No. 17/709,207, filed on Mar. 30, 2022.
(60) Provisional application No. 63/195,605, filed on Jun. 1, 2021.

(51) Int. Cl. G06Q 40/06; G06F 16/26

(52) U.S. Cl. CPC G06Q 40/06; G06F 16/26

(57) ABSTRACT

Disclosed herein is a system and method for determining one or more metrics indicative of a user's financial health. The system may present information using a financial oculus, including one or more visualizations. The visualization(s) may present financial information in a simple, but comprehensive format and may allow adjustments to one or more financial goals. The user may interact with the app and receive information regarding the impact certain changes may have. The system may also provide suggestion(s) associated with relationship(s). In some embodiments, the suggestion(s) may be determined based on the user's interaction with the financial oculus. Embodiments of the disclosure may include an interactive app that allows a user to explore the impacts of different financial goals by adjusting the properties of the visualization(s).

### CROSS-REFERENCE TO RELATED APPLICATION

The application is a divisional of U.S. patent application Ser. No. 17/709,207, filed Mar. 30, 2022, which claims the benefit of U.S. Provisional Application No. 63/195,605, filed Jun. 1, 2021, the contents of which are incorporated herein by reference in its entirety for all purposes.

### FIELD OF DISCLOSURE

This disclosure relates to systems and methods for determining and improving financial health based on a user's current or past financial health or behaviors, the user's potential financial behaviors, or both. This disclosure also relates to visualizations that illustrate one or more metrics indicative of financial health.

### BACKGROUND

Understanding one or more metrics indicative of financial health, such as credit score and debt, may be a complex task. One or more factors, like annual percentage rate (APR), credit limit, utilization, overall debt, ability to pay, and the like, may need to be determined in order to extrapolate potential solutions. A user may need to understand and be aware of the factor(s) in order to make a financial decision that aligns with one or more financial goals. It may be time consuming and difficult to decipher financial data and make meaningful decisions.

Traditional financial apps use standard form-based design components, where a user has to manually choose a payment amount for paying debt, such as the balance due. Traditional financial apps may provide the user with fixed, predetermined information such as the minimum payment amount. Such predetermined information may be determined irrespective of the user's financial health or behaviors. For example, the minimum payment amount may be an amount used for all users. Paying the minimum payment amount may not improve the user's financial health. For example, if the user pays the minimum payment amount while spending more than the minimum payment amount, the user may not be working towards reducing the debt over time.

Traditional financial apps may present information in a manner that may risk a user missing critical payment and balance information. Unlike paper statements having, e.g., a Truth in Lending Act (TILA) box, the information may be spread across different user interfaces.

What is needed is a system and method that determine one or more metrics indicative of a user's financial health and make suggestions on how to improve it. The suggestions may be in the form of tips, strategies, or options. What is needed is a system and method that suggest one or more financial goals (e.g., staying below an aspirational credit amount, paying a smart spot payment amount, etc.). Financial goals based on one or more factors such as the user's current or past financial health or behaviors, the user's potential financial behaviors, or both, may be desired.

What is also needed is a system and method that encourage or discourage user behaviors based on the user's interactions with the system and/or the one or more metrics. It may be beneficial to encourage positive behaviors and discourage negative behaviors via constructive coaching. The constructive coaching may be tailored to allow an individualized, personal user experience. What is also needed is a system and method that allow an easy-to-use process for a user to pay debt using aspirational payment amount(s). Splitting up the payment into multiple, smaller payments may help make paying off debt more manageable.

What is needed is a system and method that present one or more visualizations. The visualizations may present information to the user in a simple, but comprehensive format. It may be desirable to present visualizations that illustrate one or more metrics indicative of financial health. What is also needed is a system and method that allow a user to interact with a financial app and receive feedback, such as information regarding the impact certain changes may have. For example, the system may provide one or more suggestions, determined based on historical user behaviors (e.g., historical payments or other user interactions).

### BRIEF SUMMARY

A computer-implemented method of visualizing one or more metrics indicative of financial health of a user is disclosed. The method may comprise: displaying a financial oculus on a graphical user interface on a display; displaying, within the financial oculus, a plurality of visualizations corresponding to the one or more metrics, wherein the plurality of visualizations includes: a statement oculus visualization indicating a statement value, an activity oculus visualization indicating an activity value, and a credit oculus visualization indicating a credit amount; and updating one or more properties of the plurality of visualizations when the statement value, the activity value, or the credit amount changes. In some embodiments, displaying the plurality of visualizations comprises displaying at least two of: the statement oculus visualization, the activity oculus visualization, or the credit oculus visualization in an overlapping sphere configuration. In some embodiments, the method further comprises: displaying a plurality of text corresponding to the statement value, the activity value, and the credit amount. In some embodiments, the method further comprises: while the financial oculus is displayed on the graphical user interface on the display, receiving user input on the financial oculus; and in response to the user input, adjusting the one or more properties of the plurality of visualizations according to the user input. In some embodiments, the method further comprises: while the financial oculus is displayed on the graphical user interface on the display, receiving user input on one of the plurality of visualizations; and displaying a user interface associated with the one of the plurality of visualizations. In some embodiments, updating one or more properties of the plurality of visualizations comprises changing a size or color of the statement oculus visualization when the statement value becomes lower than an aspirational credit amount. In some embodiments, updating one or more properties of the plurality of visualizations comprises changing a size or color of the activity oculus visualization when the activity value becomes lower than a threshold percentage of an aspirational credit amount. In some embodiments, the plurality of visualizations further includes a smart spot payment visualization representative of a smart spot payment amount. In some embodiments, the method further comprises: determining the smart spot payment amount based on a threshold, a segmentation value, or a credit utilization. In some embodiments, the method further comprises: displaying a payment amount on the graphical user interface on the display; while the payment amount is displayed on the graphical user interface on the display, receiving user input on the graphical user interface; and in response to the user input, changing the payment amount displayed according to the user input. In some embodiments, the method further comprises: highlighting one of the plurality of visualizations within the financial oculus; while the financial oculus is displayed on the graphical user interface, receiving user input corresponding to a movement of a location of an aspiration visualization; and in response to the user input, changing the highlighted visualization according to the user input. In some embodiments, the method further comprises: displaying a split-payment visualization, wherein the split-payment visualization provides a plurality of split-payment option visualizations; and in response to receiving user input on one of the split-payment option visualizations, displaying a calendar visualization. In some embodiments, the method further comprises: creating one or more reminders on a user device, the one or more reminders corresponding to one or more dates selected by a user on the calendar visualization.

A method is disclosed. The method comprises: determining one or more metrics indicative of a user's financial health, wherein the one or more metrics is determined based on the user's current or past financial health or behaviors; determining one or more relationships between the one or more metrics and one or more financial goals; providing one or more messages to a user, wherein the one or more messages are associated with the one or more metrics, the one or more financial goals, or the one or more relationships; and allowing the user to set or make adjustments to the one or more financial goals. In some embodiments, the one or more metrics include one or more of: the user's credit card health, credit score, debt-to-income ratio, safety spending zone, payment amount history, average monthly activity value, statement value, activity value, or credit amount. In some embodiments, the displaying the information comprises displaying one or more of: account information at a glance, payment information, full credit balance, or the user's credit account dynamics. In some embodiments, the one or more financial goals include one or more of: having the ability to pay, paying down a balance, reducing total amount paid, reducing time until a debt is paid, improving credit score, lowering credit utilization, or achieving an aspirational credit amount. In some embodiments, the one or more messages comprise a message including the one or more metrics, the one or more financial goals, or a smart spot payment amount, a message indicating deviation away from or towards the one or more financial goals, or a personalized message providing tips or strategies. In some embodiments, the method further comprises: determining the smart spot payment amount based on a predetermined payoff time, the statement value, and the monthly activity value. In some embodiments, the method further comprises: determining the smart spot payment amount based on a threshold, a segmentation value, or credit utilization. In some embodiments, the displaying the one or more suggestions comprises displaying a financial oculus comprising one or more visualizations, wherein one or more properties of the one or more visualizations are indicative of or related to the one or more metrics or the one or more financial goals. In some embodiments, the method further comprises: using the one or more visualizations to encourage the user to work towards the one or more financial goals. In some embodiments, allowing the user to set or make adjustments to the one or more financial goals comprises allowing the user to adjust the one or more properties of the one or more visualizations. In some embodiments, the method further comprises: displaying a countdown visualization, wherein one or more properties of the countdown visualization are indicative of an urgency of a payment due.

A non-transitory computer readable medium, the computer readable medium including instructions that, when executed, perform a method of visualizing one or more metrics indicative of financial health is disclosed. In some embodiments, the method comprises: displaying a financial oculus on a graphical user interface on a display; displaying, within the financial oculus, a plurality of visualizations corresponding to the one or more metrics, wherein the plurality of visualizations includes: a statement oculus visualization indicating a statement value, an activity oculus visualization indicative an activity value, and a credit oculus visualization indicative a credit amount; and updating one or more properties of the plurality of visualizations when the statement value, the activity value, or the credit amount changes.

### DESCRIPTION OF THE DRAWINGS

FIG. 1 illustrates an exemplary view of a user interface (UI) displaying an initial screen of a financial app, according to embodiments of the disclosure.

FIGS. 2A and 2B illustrate exemplary views of UIs displaying home screens of a financial app, according to embodiments of the disclosure.

FIG. 3 illustrates an exemplary view of a recent transactions UI, according to embodiments of the disclosure.

FIGS. 4A-4C illustrate exemplary financial oculi and corresponding text, according to embodiments of the disclosure.

FIGS. 5A-5G illustrate exemplary payments UIs, according to embodiments of the disclosure.

FIG. 5H illustrates a flow chart of an exemplary method for determining a smart spot payment amount, according to embodiments of the disclosure.

FIG. 51 illustrates a flow chart of an exemplary method for determining a smart spot payment amount for improving a user's credit score, according to embodiments of the disclosure.

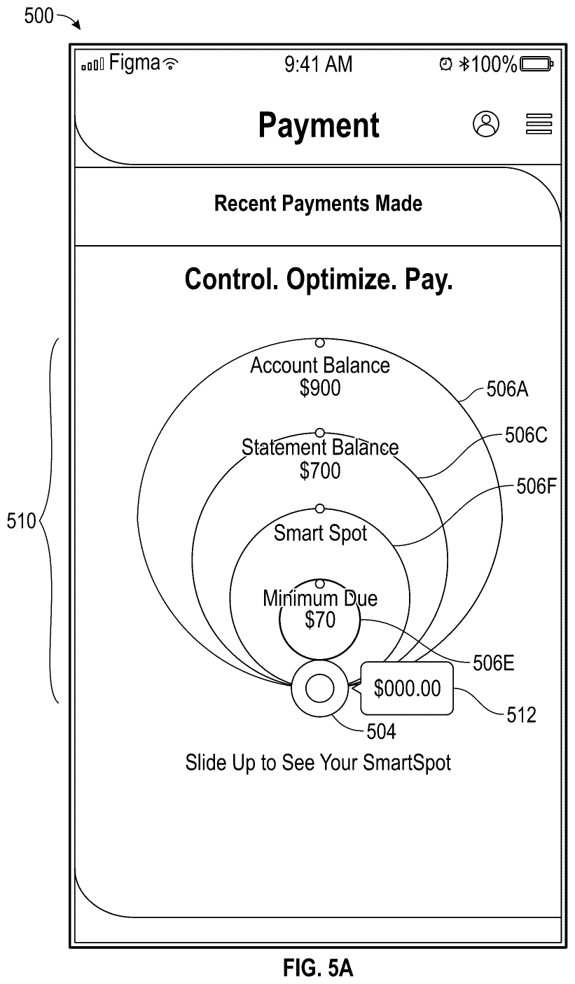

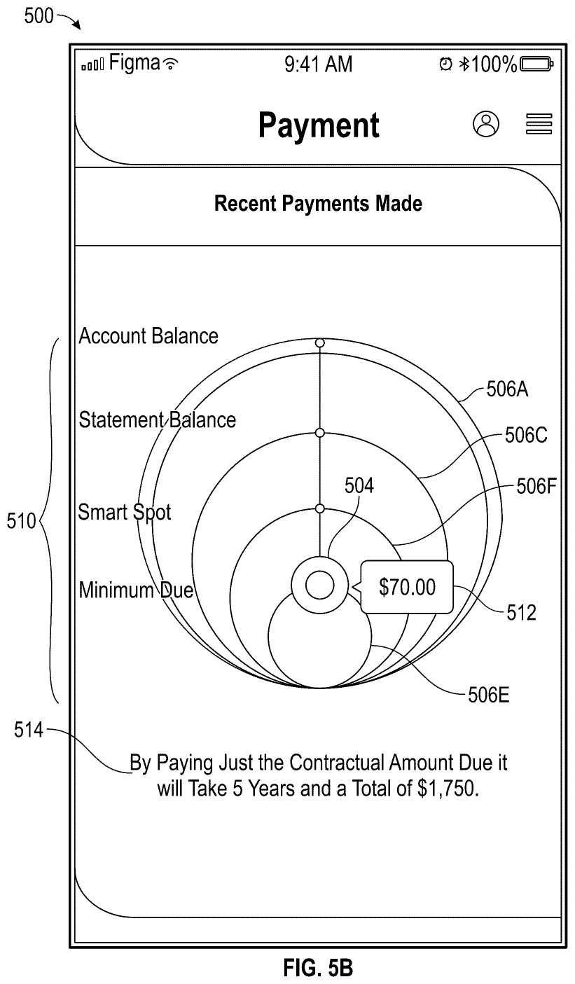

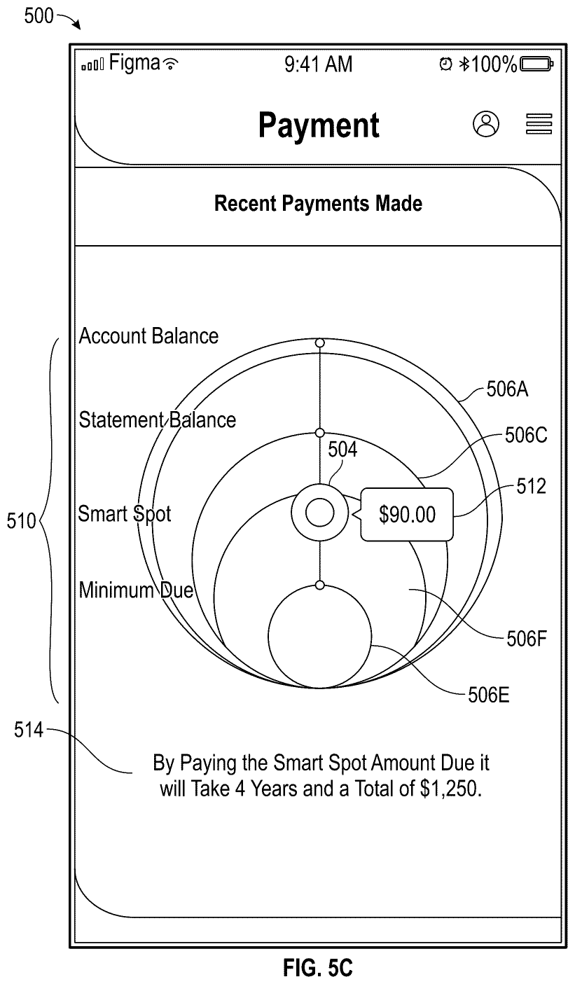

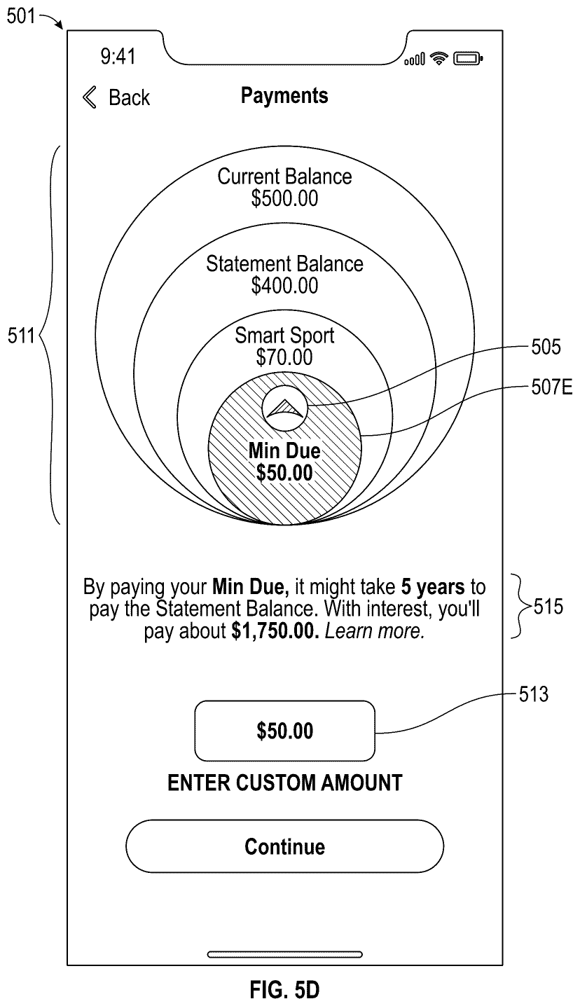

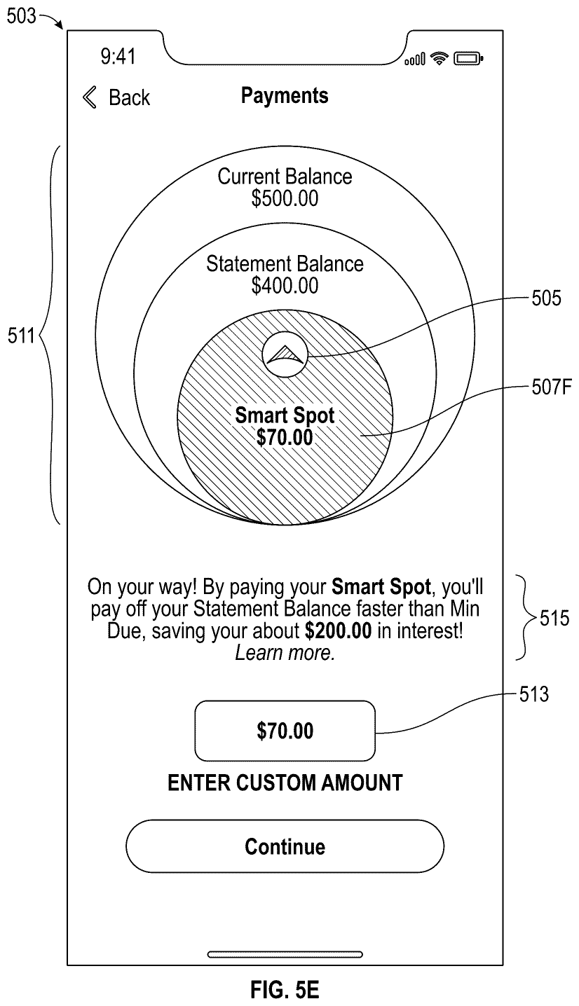

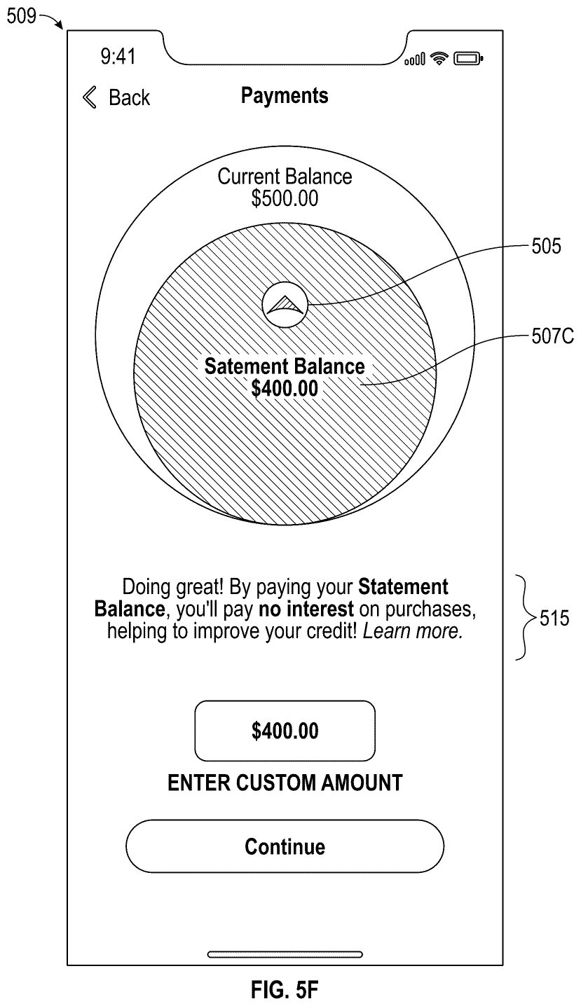

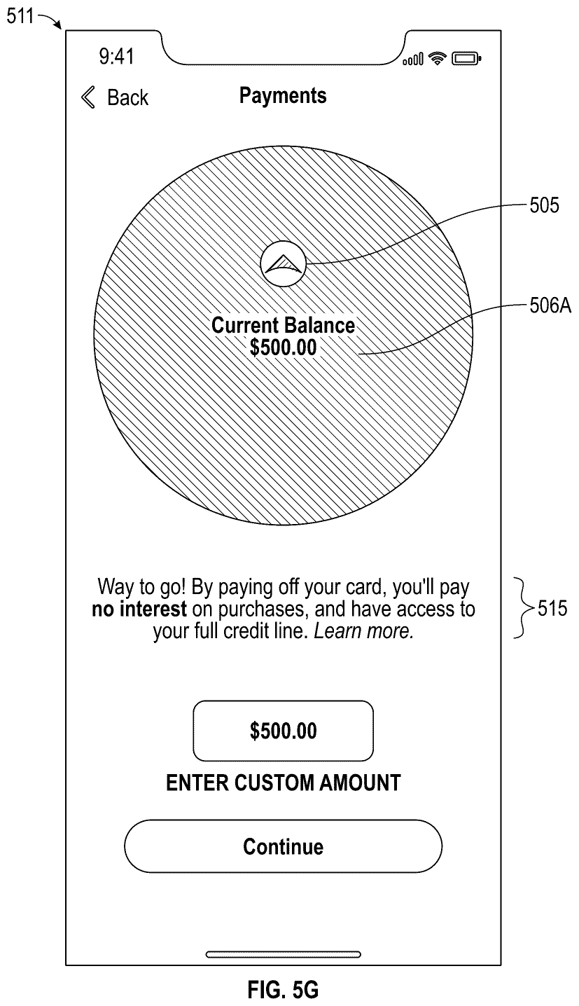

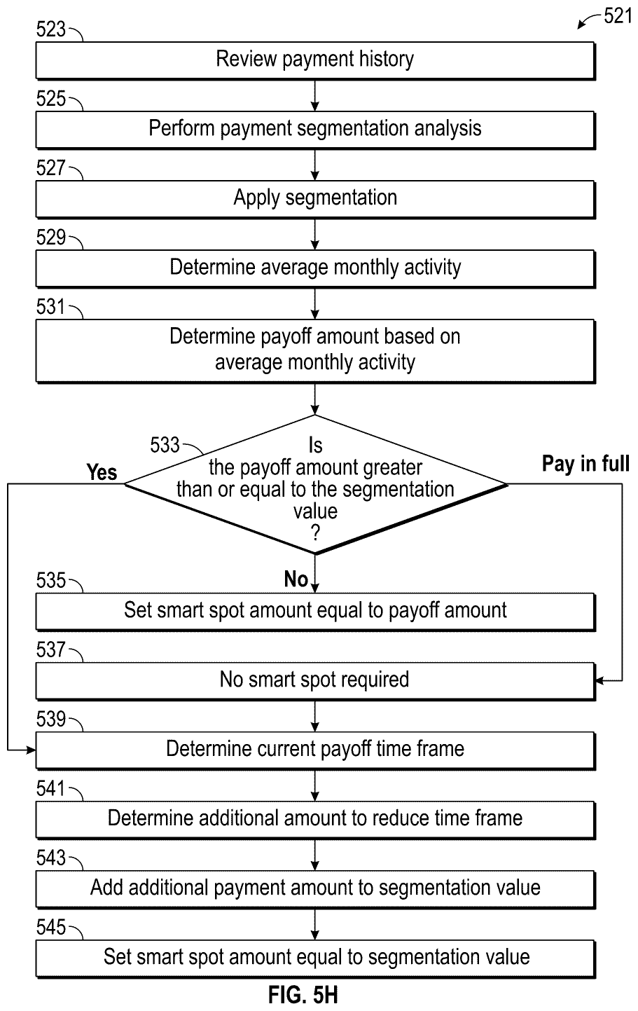

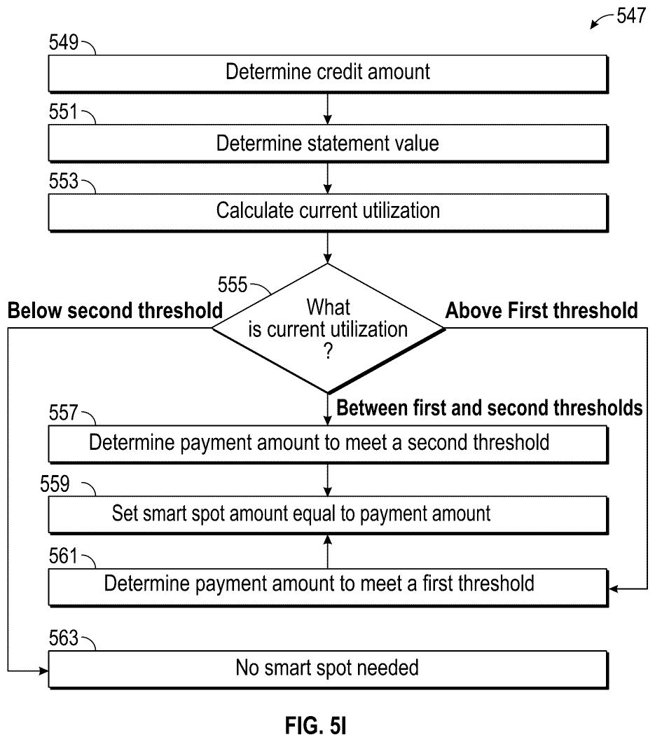

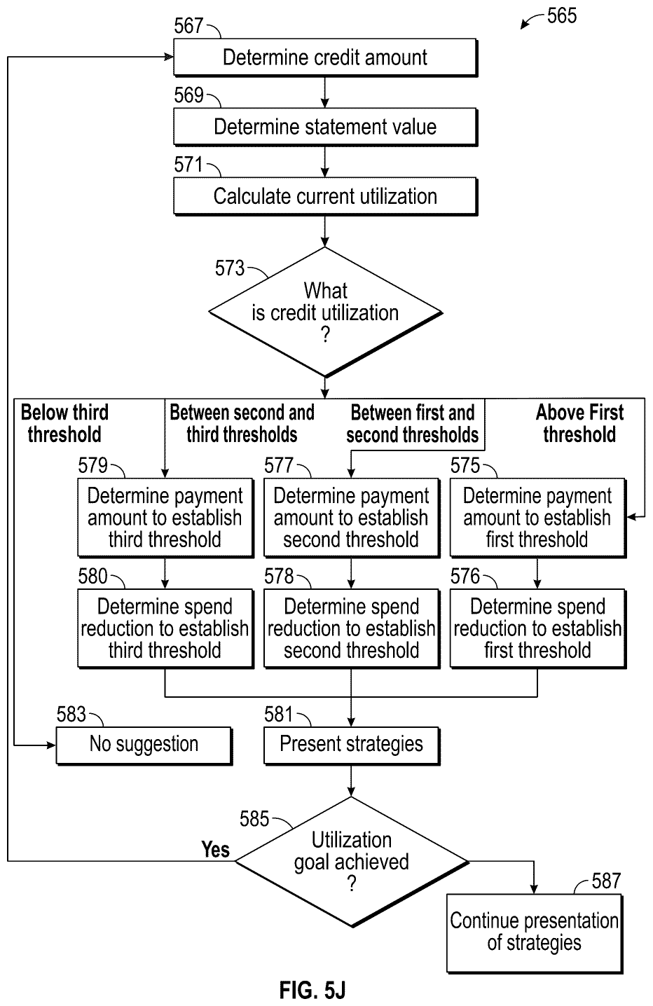

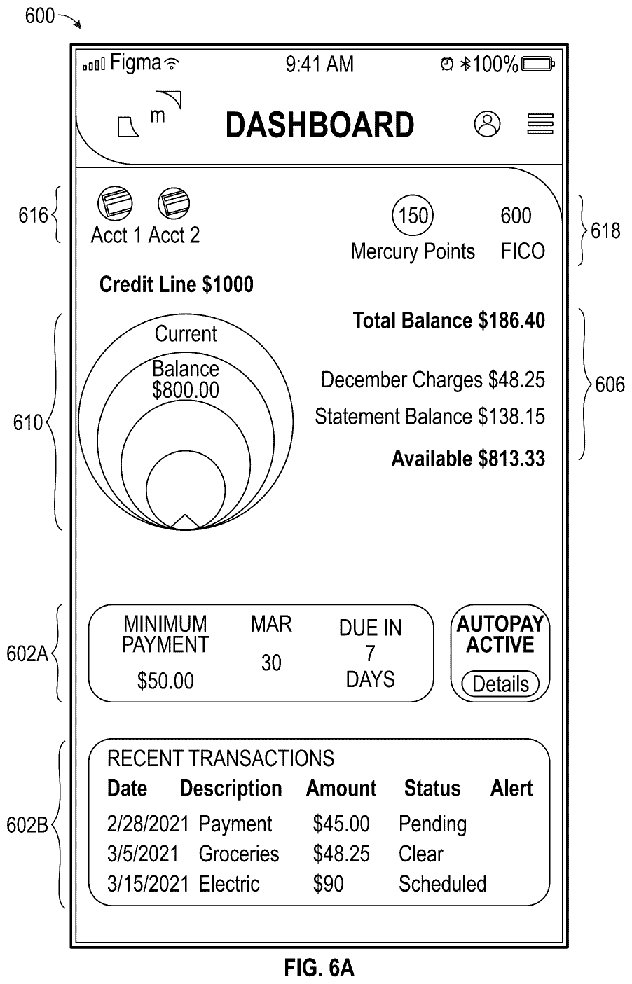

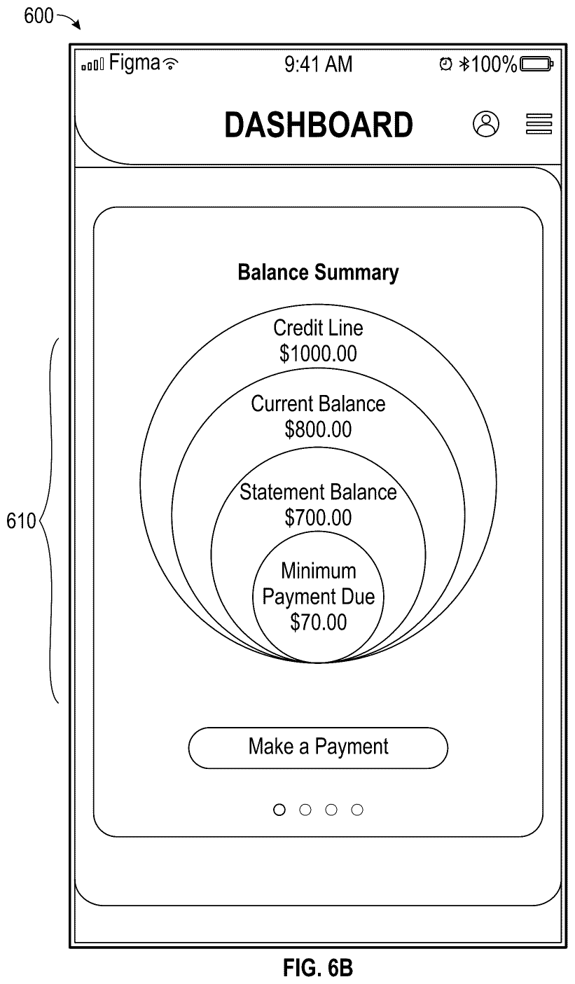

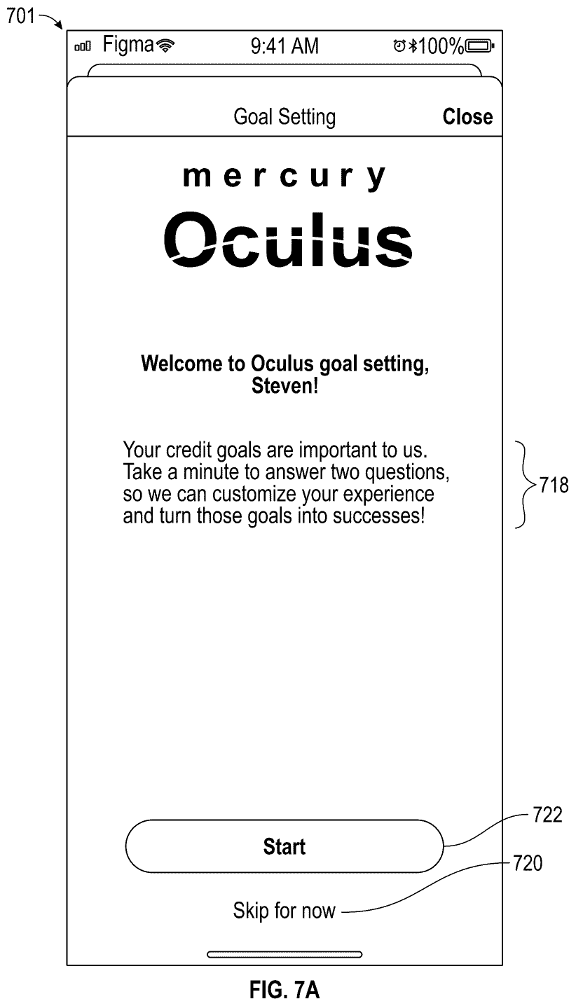

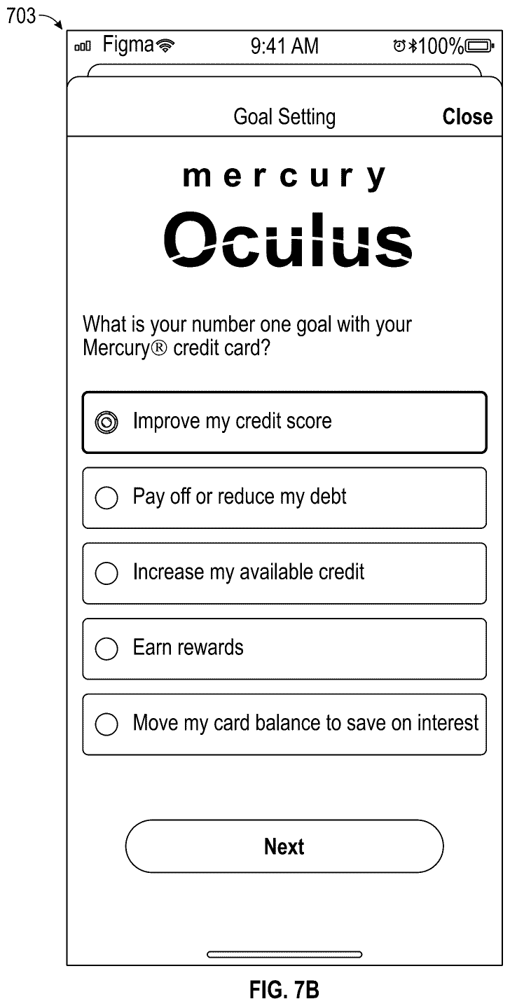

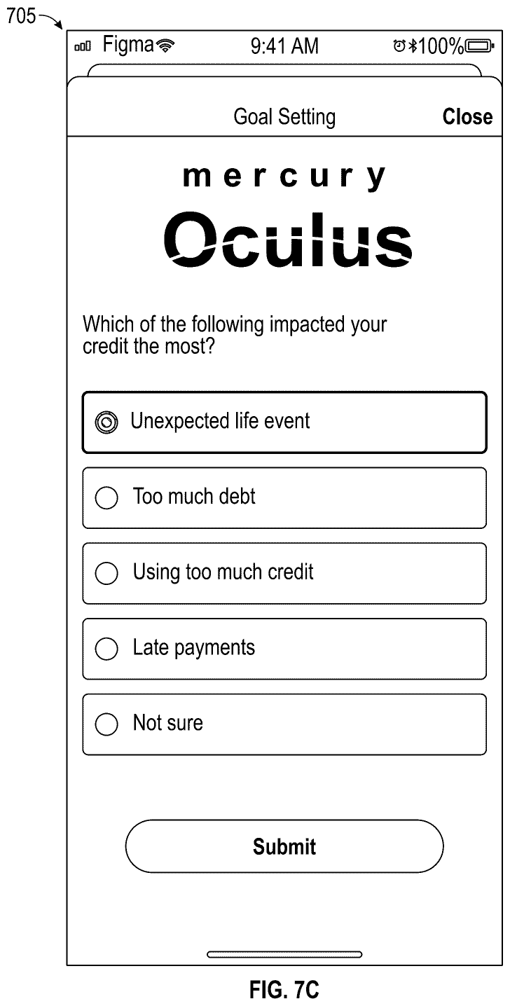

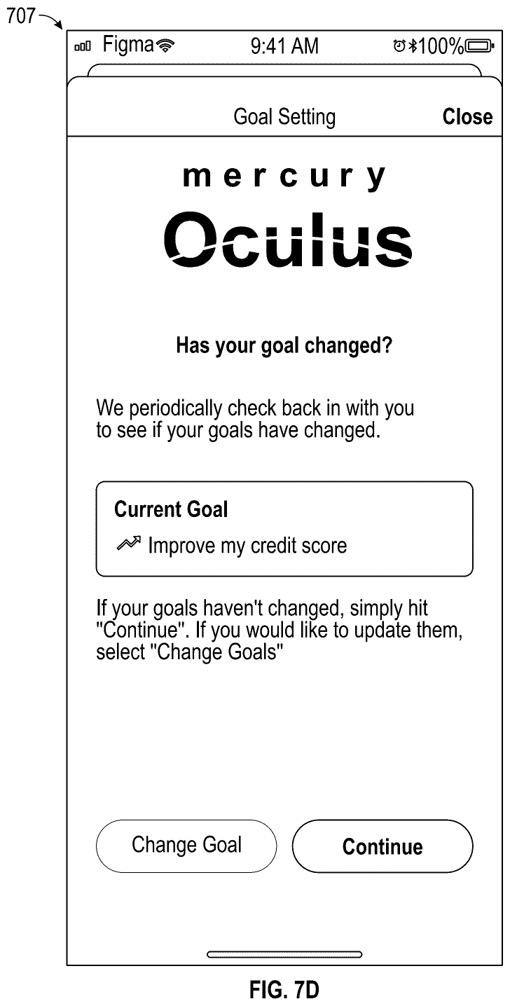

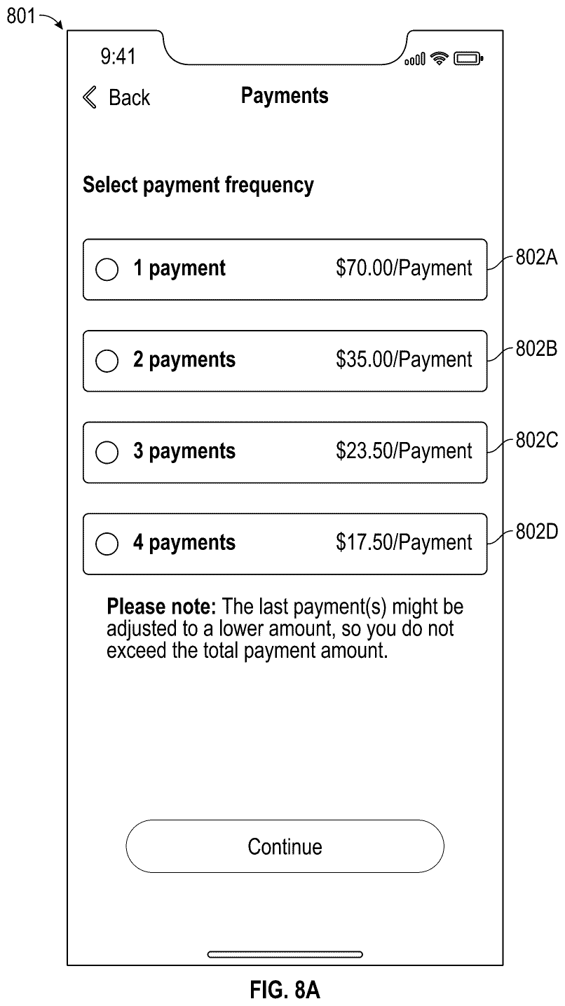

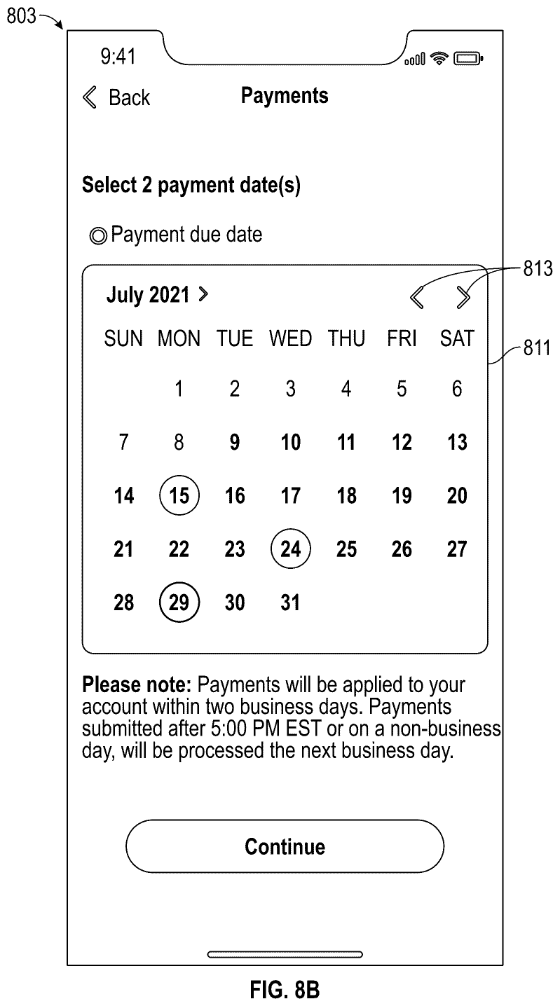

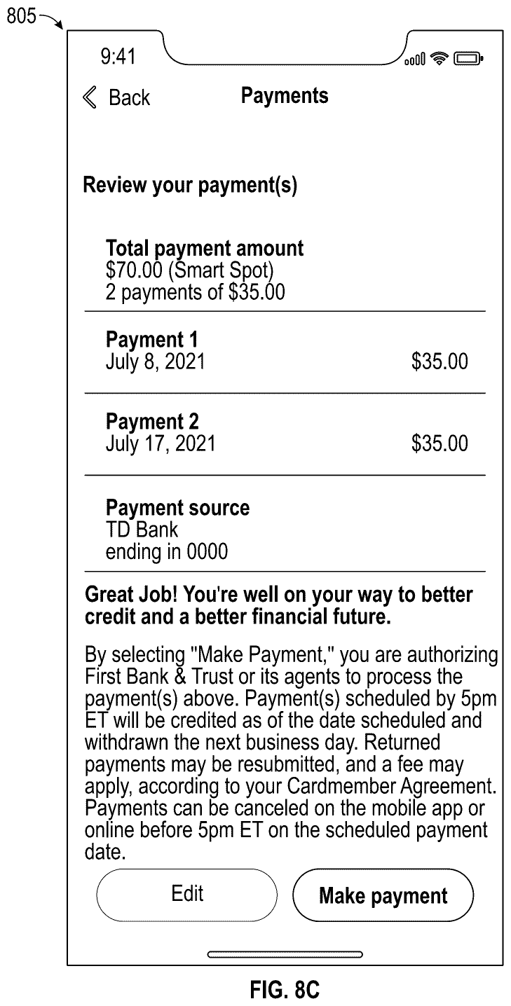

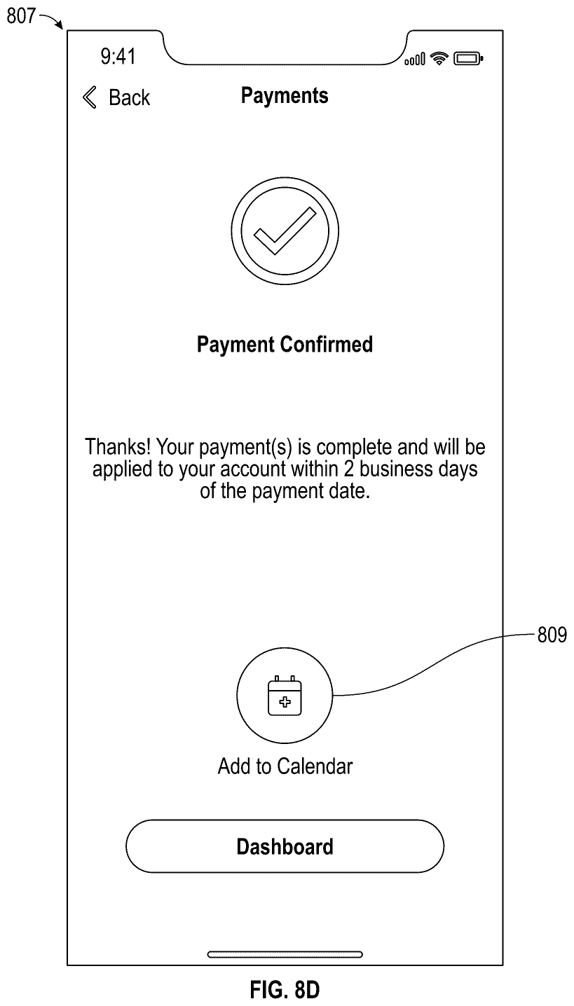

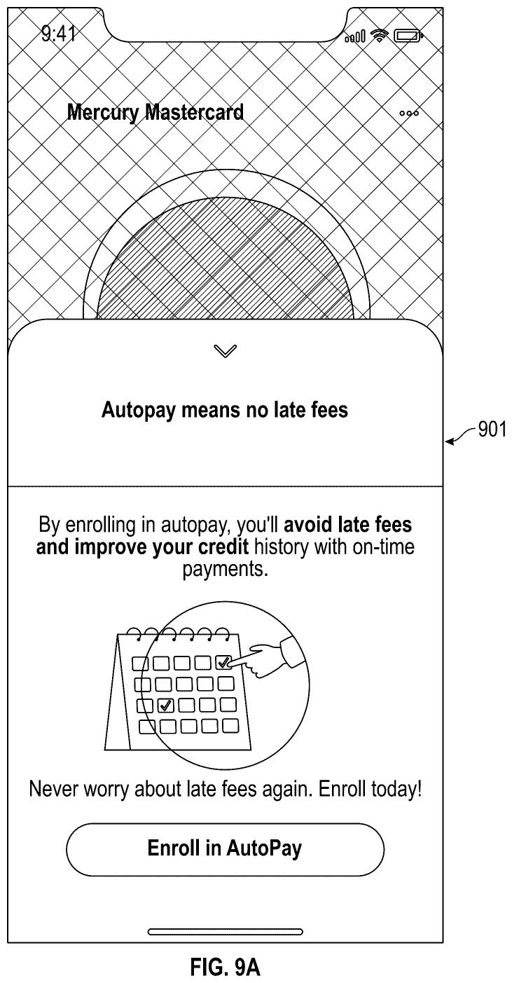

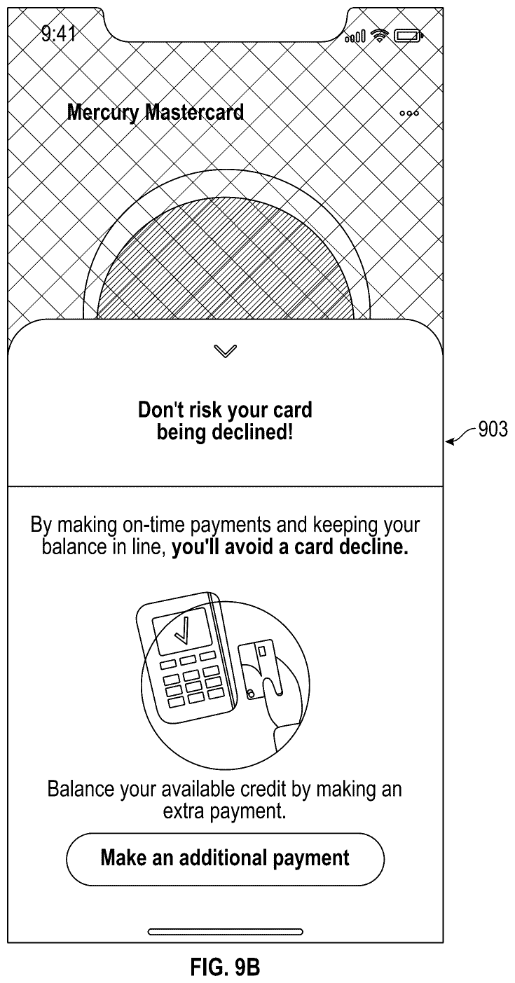

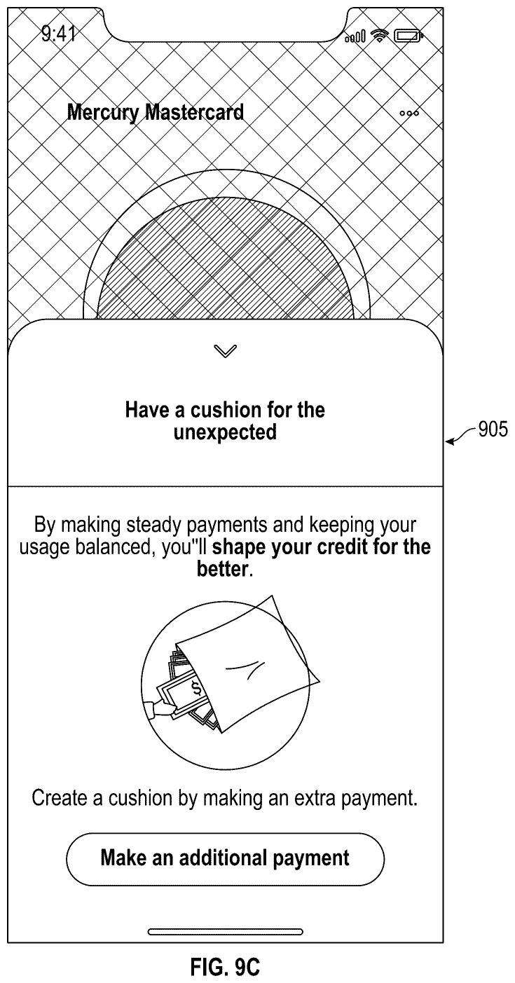

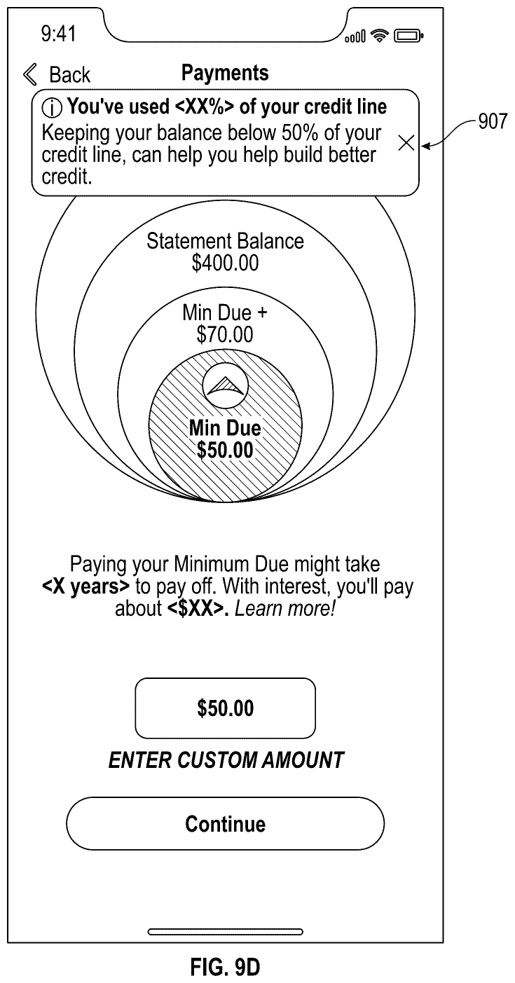

FIG. 5J illustrates a flow chart of an exemplary method for determining a budget strategy, according to embodiments of the disclosure.

FIGS. 6A and 6B illustrate exemplary initial dashboard UIs, according to embodiments of the disclosure.

FIGS. 7A-7D illustrate exemplary goal setting UIs, according to embodiments of the disclosure.

FIGS. 8A-8D illustrate exemplary split-payment UIs, according to embodiments of the disclosure.

FIGS. 9A-9D illustrate exemplary messages provided to the user, according to embodiments of the disclosure.

FIGS. 9E and 9F illustrate flow charts of exemplary methods for generating or selecting a personalized message, according to embodiments of the disclosure.

FIG. 10 illustrates a block diagram of an exemplary system, according to embodiments of the disclosure.

### DETAILED DESCRIPTION

Disclosed herein are systems and methods for determining one or more metrics indicative of a user's financial health. In some embodiments, the user's financial health may be based on the financial health for one or more financial accounts, such as a user's credit card. The one or more metrics may include, but are not limited to, the user's credit card health, credit score, debt-to-income ratio, etc. The metric(s) may be based on one or more lines of credit amount, current balance due (statement value), payment history, spending, credit utilization, ability to pay, and the like.

The system may present information using a financial oculus. The financial oculus may include one or more visualizations. The visualization(s) may present information in a simple, but comprehensive format. The information presented may include the user's account information such as account information at a glance, payment information, full credit balance, credit account dynamics, etc. The visualization(s) may allow the user to make adjustments to one or more financial goals such as the user's ability to pay, the desired payment amount, time until the debt is paid off (payoff time), etc. The financial oculus may include a plurality of visualizations, such as spheres, each corresponding to a metric of financial health. The financial oculus may provide the user with a complete picture of the user's current financial health on one screen, and in some embodiments, may provide the user with tips or strategies for improving the user's financial health or related predictions.

One or more properties of the visualizations may be indicative of one or more metrics or one or more financial goals. A visualization (e.g., a circle or sphere) may represent the user's total line of credit, for example. The visualization may show the user's safety spending zone (a metric) to inform the user that the user can only spend within the limits of the spending zone limit. Another visualization may be one that represents a smart spot payment amount. The “smart spot” payment amount may be a suggested amount determined by the system to help improve the user's financial health. The smart spot payment amount may be determined based on the user's current or past financial health or behaviors, including one or more past payment amounts (the payment amount history) and the user's spending habits, as non-limiting examples.

In some embodiments, the user may be allowed to change the financial oculus information. For example, the financial oculus information may include current balance, payment amount to the balance due, statement balance, and payment amount to a credit card. Each piece of information may be represented by a unique visualization (e.g., a sphere) of the financial oculus.

The size, shape, and/or color of a sphere may be determined based on the value of the corresponding financial oculus information. The user may be able to adjust the size of one or more spheres, which may change the respective financial oculus information (one or more metrics, one or more financial goals, etc.). While the financial oculus is displayed, the system may receive user input on the financial oculus. In response to user input, the system may adjust one or more properties of the financial oculus and financial oculus information according to the user input. Exemplary properties may include, but are not limited to, the size, shape, and/or color of a visualization, the corresponding text, etc.

Tips or strategies may be presented in the form of one or more messages via an interstitial. The interstitial may include one or more visualizations. The messages may provide one or more tips, strategies, or both to help the user make an informed decision related to the user's financial health. For example, the messages may help the user get on track towards better credit, or inform the user that he or she is on the right track to towards better credit. In some embodiments, the messages may be provided to the user in real-time.

The system may determine one or more relationships between one or more metrics. The one or more relationships may be associated with one or more financial goals. In some embodiments, one or more goals may be set by the user. For example, the system may determine and display the relationship between a user's credit card balance and a payment amount. The user may be able to select a desired payment amount, and the system may automatically adjust the credit card balance in response and based on the relationship. In this manner, the user may be able to interact with the app and receive information regarding the impact certain changes may have, such as what affect a certain payment amount may have on the credit card balance.

The system may also provide one or more suggestions associated with the one or more relationships. In some embodiments, the suggestion(s) may be determined based on the user's interaction with the financial oculus. Using the same example, the system may suggest a higher payment amount (than the amount selected by the user) and show how the higher payment amount would affect the user's credit card balance.

Embodiments of the disclosure may include an interactive app that allows a user to explore the impacts of different financial goals (e.g., payment options such as payment amounts). The impacts may include predicted results from paying down a balance, reducing the length of time to pay off a debt (payoff time), the effect on the total amount paid, etc. The different payment options may include the minimum payment amount and amounts above the minimum payment amount. The app may provide the user with a comparison of the different impacts when paying the minimum amount and one or more different amounts above the minimum.

In some embodiments, the system may determine the metric(s) while also considering one or more factors representative of the user's current or past financial health or behaviors. For example, the system may determine a user's payment strategy based on the user's credit score and the user's current financial budget. The payment strategy may be a suggestion presented to the user, wherein the suggestion is associated with the relationships between the payment strategy, the user's credit score, and the user's current financial budget. The system may determine a payment amount within the user's current financial budget that also improves the user's credit score. In some embodiments, the system may allow the user to split up the total payment amount into multiple, smaller payment amounts to help make paying off debt more manageable for the user.

The following description is presented to enable a person of ordinary skill in the art to make and use various embodiments. Descriptions of specific devices, techniques, and applications are provided only as examples. These examples are being provided solely to add context and aid in the understanding of the described examples. It will thus be apparent to a person of ordinary skill in the art that the described examples may be practiced without some or all of the specific details. Other applications are possible, such that the following examples should not be taken as limiting. Various modifications in the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various techniques and process flow steps will be described in detail with reference to examples as illustrated in the accompanying drawings. In the following description, numerous specific details are set forth in order to provide a thorough understanding of one or more aspects and/or features described or referenced herein. It will be apparent, however, to a person of ordinary skill in the art, that one or more aspects and/or features described or referenced herein may be practiced without some or all of these specific details. In other instances, well-known process steps and/or structures have not been described in detail in order to not obscure some of the aspects and/or features described or referenced herein.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combination of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

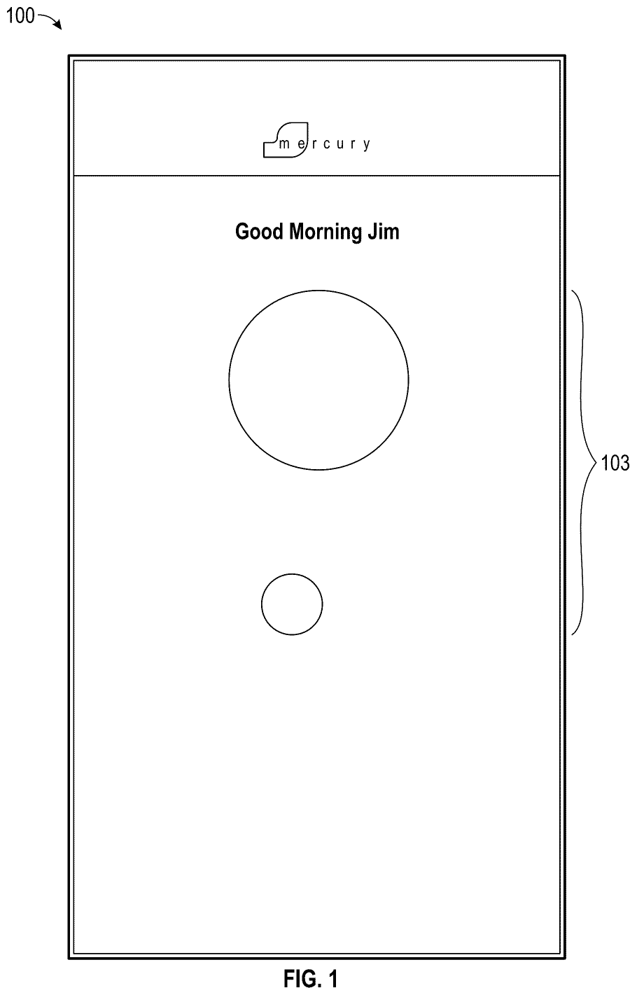

FIG. 1 illustrates an exemplary view of a UI displaying an initial screen of a financial app, according to embodiments of the disclosure. The initial screen 100 may be a UI displayed on the display of a device (e.g., a mobile phone, a tablet, a laptop computer, etc.) when the app is first started. The initial screen 100 may include a graphical animation, such as a first graphical user interface (GUI) 103 moving down the initial screen 100, at a first time. At a second time, the display show a home screen.

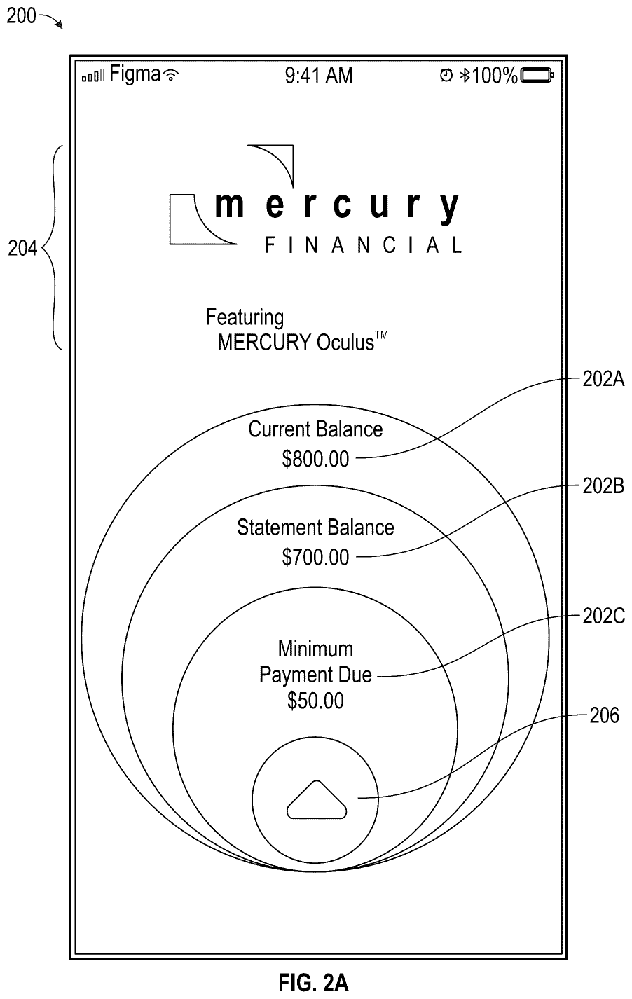

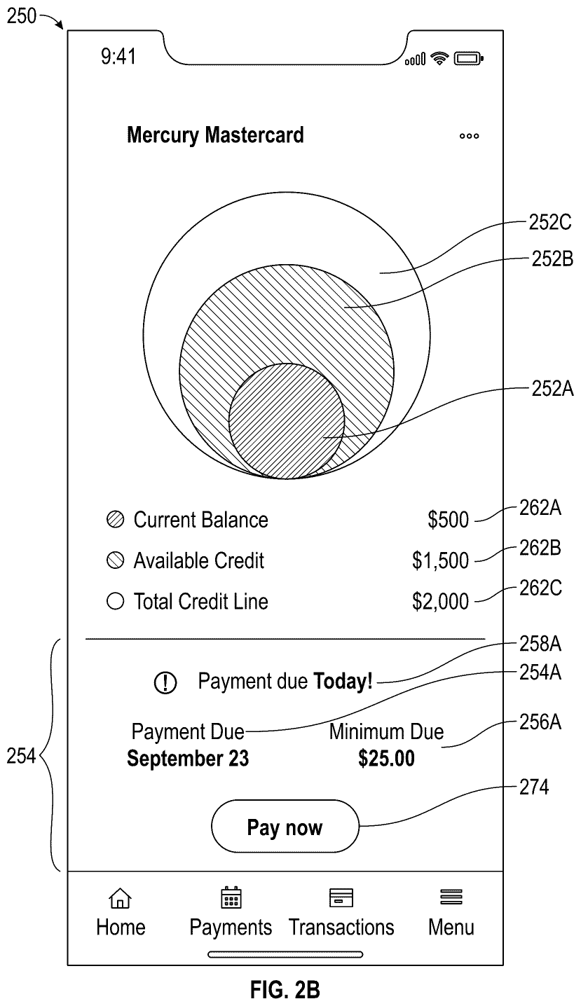

FIG. 2A illustrates an exemplary view of a UI displaying a home screen of a financial app, according to embodiments of the disclosure. The home screen 200 may include one or more first visualizations 202 and one or more second visualizations 204. The visualizations may be included in a financial oculus, for example. The home screen 200 may provide a summary of the financial oculus information, such as the current balance shown in the oculus visualization 202A, the statement balance shown in the oculus visualization 202B, and the minimum payment due shown in the oculus visualization 202C. The text visualization 204 may be one that is not associated with text, in some embodiments. Although the figure shows four visualizations, embodiments of the disclosure may include any number and type of visualizations.

In some embodiments, a visualization may be a GUI button that when clicked (e.g., tapped, pressed, held down, etc.) may activate a function such as redirecting the user to another UI. When the user clicks on the button visualization, the system may receive the user input while the financial oculus is displayed. In some embodiments, a button visualization may redirect the user (when the user clicks on the button visualization) by displaying a UI associated with the visualization. In some embodiments, the oculus visualizations 202 may be associated with different UIs. For example, receiving user input via clicking on the oculus visualization 202A may redirect the user to a recent transactions UI, clicking on the oculus visualization 202B may redirect the user to a statements UI, and clicking on the oculus visualization 202C may redirect the user to a payments UI. When the user clicks on the text visualization 204, the system may redirect the user to a dashboard UI, for example, displaying the UI associated with the visualization that the user interacted with.

Embodiments of the disclosure may include an aspiration visualization 206. The aspiration visualization 206 may be configured to providing an encouragement to the user regarding one or more financial goals (e.g., make a higher payment), for example. Encouraging the user to make a higher payment (e.g., higher than the minimum payment amount due) may lead to lowering the user's credit utilization (financial goal).

In some embodiments, the home screen may comprise a financial oculus in addition to payment information. FIG. 2B illustrates an exemplary view of a UI displaying a home screen of a financial app, according to embodiments of the disclosure. The home screen 250 may include one or more oculus visualizations 252 and corresponding text 262. The oculus visualization 252A and first text 262A may represent the current balance (e.g., $500 in the illustrated example). The oculus visualization 252B and second text 262B may represent the available credit (e.g., $1,500 in the illustrated example). The oculus visualization 252C and third text 262C may represent the total line of credit (e.g., $2,000 in the illustrated example). The properties of oculus visualizations 252 of the may reflect the corresponding text 262. For example, the oculus visualization 252A (representing current balance) may be smaller than the oculus visualization 252B (representing available credit), reflecting the current balance as being less than the available credit. Although the figure shows three visualizations, embodiments of the disclosure may include any number and type of visualizations.

The home screen 250 may further comprise another visualization 254, such as a payment visualization. The payment visualization 254 may include payment information such as a payment due date text 254A, the minimum payment amount due text 256A, and a countdown visualization 258A. The countdown visualization 258A may be updated (e.g., periodically, such as daily) to reflect an up-to-date timeframe related to the next payment due (e.g., “Payment due Today!”). In some embodiments, the countdown visualization 258A may not include a specific number of days until the next payment due date. For example, the countdown visualization 258A may display “Minimum payment due” when the next payment due date is a threshold number of days (e.g., 20 days) away, or “Payment already scheduled” when the payment has been scheduled to automatically occur at a future time. In some embodiments, the countdown visualization may have one or more properties indicative of the urgency of the payment due. For example, the text in the countdown visualization may change to a certain color (e.g., red) when the payment due date is within a threshold number of days from the current date to signal to the user the payment due date is soon approaching.

The payment visualization 254 may also include a payment GUI button 274. The payment GUI button 274 may display the text “Pay now” when the next payment is due, or “Pay more” when the next payment has already been paid. When clicked, the payment GUI button 274 may redirect the user to a payments UI, for example.

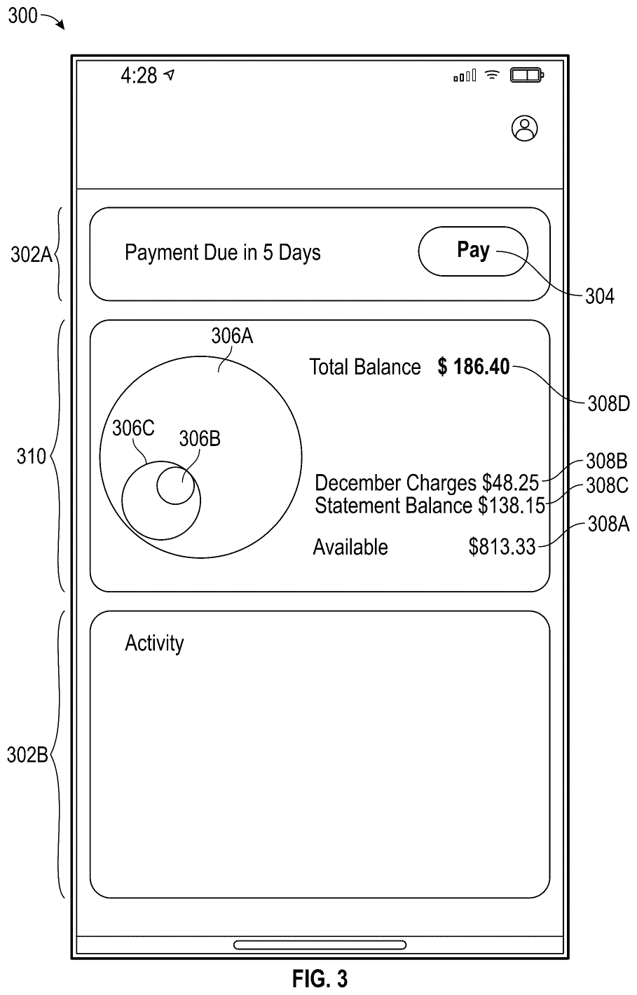

FIG. 3 illustrates an exemplary view of a recent transactions UI, according to embodiments of the disclosure. The recent transactions UI 300 may include a plurality of visualizations. The payment visualization 302A may provide payment information, such as when the next payment is due, and a payment GUI button 304. When clicked, the payment GUI button 304 may redirect the user to a payments UI, for example. The recent activity visualization 302B may provide detailed recent activity information (none, as shown).

The financial oculus 310 may provide financial information using one or more oculus visualizations 306A, 306B, and 306C. A visualization may represent a metric (e.g., statement value, activity value, credit amount) or a financial goal, for example. The visualizations (e.g., statement visualization, activity visualization, credit visualization, etc.) may be displayed in an overlapping sphere configuration, for example, as shown in the figure. In an overlapping sphere configuration, at least one sphere appears as located within another sphere. For example, the sphere for oculus visualization 306B appears as located within the sphere for oculus visualization 306C (and the sphere for oculus visualization 306A).

The financial oculus 310 may have one or more corresponding text 308A, 308B, and 308C. The plurality of text 308 may be displayed within the financial oculus 310, for example. The credit oculus visualization 306A and the credit text 308A may represent the user's available credit amount. The activity oculus visualization 306B and the activity text 308B may represent the user's charges based on recent activity (e.g., since the last statement) (also referred to as the activity value). The statement oculus visualization 306C and the statement text 308C may represent the user's statement balance (also referred to as the statement value). The UI may also display total balance text 306D, which may be user's total balance. In some embodiments, the user's total balance may be equal to the sum of the activity value and the statement value.

The properties of the visualizations (e.g., oculus visualizations 306) and the values in the text 308 may update as a user makes a purchase (the activity value changes) or submits a payment (the statement value changes). For example, if the user makes a purchase using a credit card, the user's available credit in the credit text 308A, the user's charges shown in the activity text 308B, and the user's total balance 308D may change according to the amount of the user's purchase. The size of the activity oculus visualization 306B representing the user's charges may change (e.g., get bigger) in response to the user's purchase. Since the size of the activity oculus visualization 306B changes, the space of the credit oculus visualization 306A not occupied (negative space that is not overlapping) by the activity oculus visualization 306B and the statement oculus visualization 306C (representing available credit) may become smaller. In some embodiments, one or more visualizations may be indicative of and related to a financial goal, such as the area of the negative space being indicative of the user's credit amount, where the user's financial goal may be to increase the credit amount.

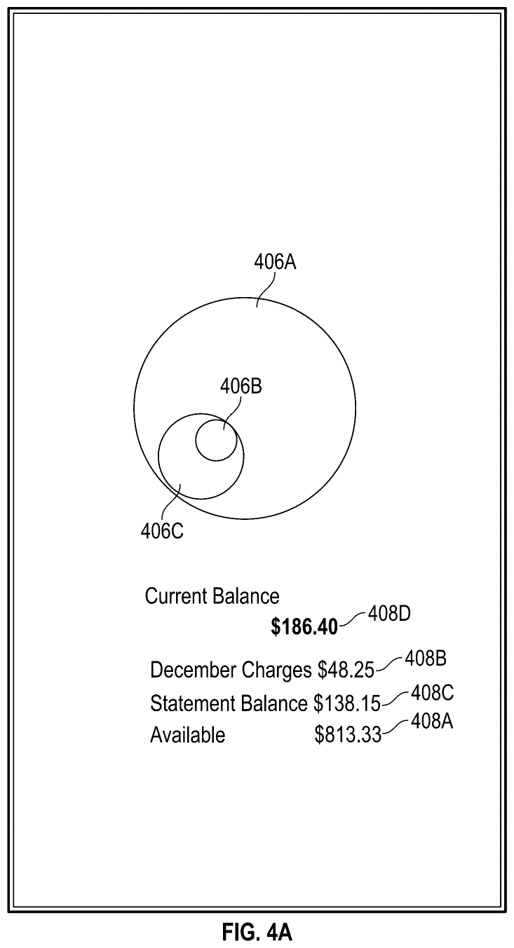

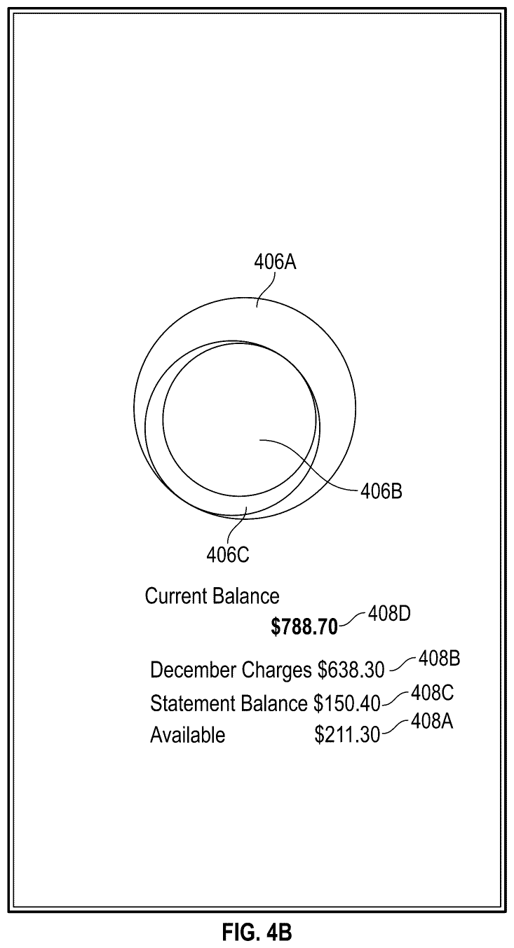

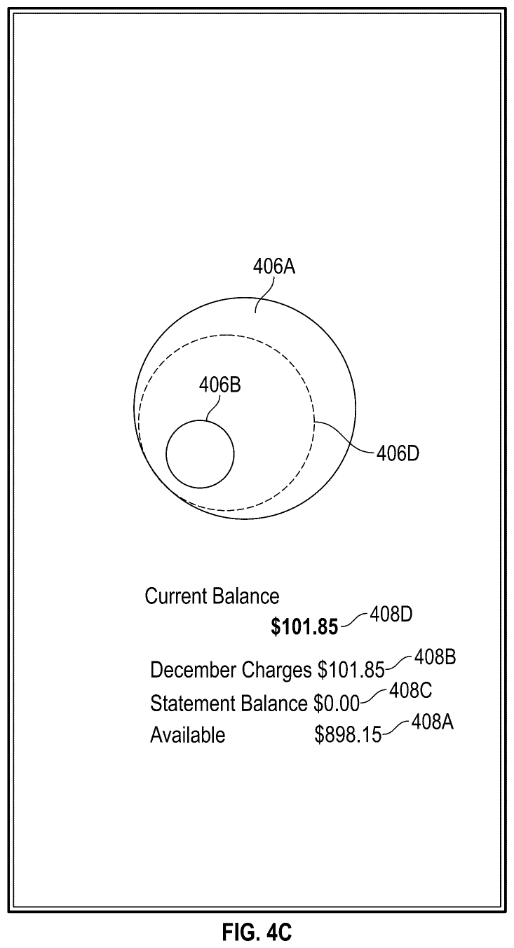

FIGS. 4A-4C illustrate exemplary financial oculi and corresponding text, according to embodiments of the disclosure. As discussed above, a financial oculus may update as the user makes a purchase and the activity value changes, or the user makes a payment and the statement value changes.

FIG. 4A illustrates a financial oculus before a user makes an exemplary purchase. The user may have a $1,000 line of credit (also referred to as credit amount), represented by the size of the credit oculus visualization 406A. The user may have spent $48.25 in the current month of December (current spending), as shown by the activity oculus visualization 406B and activity text 408B. The user may have a statement balance of $138.15 (from previous statements), as shown by the statement oculus visualization 406C and the statement text 408C. The total balance text 408D may display the user's total balance of $186.40, equal to the user's current spending and the statement balance. The space of the credit oculus visualization 406A not occupied (negative space) by the activity oculus visualization 406B and the statement oculus visualization 406C, along with the credit text 408A, may show that the user has $813.33 available to spend.

The visualizations and their properties may illustrate various financial information. For example, the statement oculus visualization 406C may have a first size and/or color based on its corresponding statement value being higher than a first threshold. The first size and/or color may change when its corresponding statement value becomes lower than the first threshold. The first threshold may be an aspirational credit amount, for example. The size of the statement oculus visualization 406C may represent the statement value. A larger first size may represent a larger statement value, and a smaller first size may represent a smaller statement value. In some embodiments, the first color of the statement oculus visualization 406C may be based on its corresponding statement value being higher than an aspirational credit amount. If the statement value is greater than the aspirational credit amount, than the statement oculus visualization 406C may be red, for example. If the statement value is less than the aspirational credit amount, than the statement oculus visualization 406C may be green, for example. The properties (e.g., size, color, etc.) of the statement oculus visualization 406C may indicate that the user's statement value is over the aspirational credit amount, for example.

The activity oculus visualization 406B may have a second size and/or color based on its corresponding activity value being higher than a second threshold. The second size and/or color may change when its corresponding activity value becomes lower than the second threshold. In some embodiments, the second threshold may correspond to a threshold percentage of the first threshold. For example, the second threshold may be 75% of the aspirational credit amount. The size of the activity visualization 406B may represent the activity value. A larger second size may represent a larger activity value, and a smaller size may represent a smaller activity value. In some embodiments, the second color of the activity oculus visualization 406B may be based on its corresponding activity value being higher than a spending-to-debt percentage (also referred to as a current utilization). The spending-to-debt percentage may be the percentage of the user's current spending relative to the statement value. If the activity value is greater than the spending-to-debt percentage, than the activity oculus visualization 406B may be red, for example. If the activity value is less than the spending-to-debt percentage, than the activity oculus visualization 406B may be green, for example. The size and color of the activity oculus visualization 406B may indicate that the user has been spending too much recently, for example.

Embodiments of the disclosure may include the visualization(s) having one or more other properties indicative of an associated factor. For example, other colors may be used to indicate the dominate category for the user's spending. If the user's recent spending has been on travel, the activity oculus visualization 406B may have a color of purple. If the user's recent spending has been on dining out, the activity oculus visualization 406B may have a color of orange.

In some embodiments, one or more visualizations may share a common space in the financial oculus. For example, the space for the activity oculus visualization 406B may overlap (e.g., be a subset of) with the space for the statement oculus visualization 406C. The size of the overlapping space may indicate a percentage of the statement value that is from the activity value. The size of the negative space (non-overlapping space) may indicate a percentage of the statement value that is from past activity, such as activity from previous statements.

Embodiments of the disclosure may include increasing the size of certain visualizations and updating text to reflect the user's spending activity. FIG. 4B illustrates the financial oculus and associated text after the user makes the purchase. In the illustrated example, the user made one or more purchases in the current month of December in the amount of $602.30. As a result, the activity text 408B changes to $638.30, and the size of the activity oculus visualization 406B increases accordingly. The user may have also been charged fees associated with the last statement, causing the statement text 408C to increase to $150.40, and the size of the statement oculus visualization 406C can increase accordingly. The credit text 408A and the total balance text 408D may also update to reflect the changes to the user's recent activity and statement balance.

Embodiments of the disclosure may include decreasing the size of certain visualizations and updating text to reflect the user's payment activity. FIG. 4C illustrates the financial oculus and associated text after the user submits a payment. The user may submit a payment of $686.85 to pay off the statement balance of $150.40 and apply the remainder to the charges of the current month (December). The statement text 408C may update to $0.00, and the size of the statement oculus visualization 406C may reflect the change. In some embodiments, the statement oculus visualization 406C may not appear on the financial oculus, as shown in the figure. The activity text 408B may decrease to $101.85, reflecting the amount remaining after applying the remainder of the submitted payment. Additionally, the activity oculus visualization 406B may decrease in size. The space of the credit oculus visualization 406A not occupied (negative space) by the activity oculus visualization 406B and the statement oculus visualization 406C may appear bigger. Both the credit text 408A and the total balance text 408D may be updated to reflect the changes to the user's recent activity and statement balance.

Embodiments of the disclosure may include using one or more goals to encourage the user to improve financial health. The goal(s) may be user-imposed or system-imposed. Exemplary goals may include, but are not limited to, credit score improvement, debt reduction, budgeting, etc. The user may interact with the financial oculus to change one or more goals, such as increasing the user's goal credit score within a credit score spectrum. The system may display one or more actions needed to achieve the goal. Exemplary actions may include, but are not limited to, reducing spending patterns, increasing payment size and frequency, making payments on time, reducing monthly spend, reducing credit utilization, etc.

FIG. 4C illustrates an aspirational credit oculus visualization 406D. The aspirational credit oculus visualization 406D may represent a user-imposed aspirational credit amount that the user can use to compare to the recent activity amount, the statement balance amount, the current balance amount, or a combination thereof. The system may allow the user to change the aspirational credit amount by adjusting the one or more properties (e.g., size) of the aspirational credit oculus visualization 406D. In some embodiments, an adjustment to the aspirational credit amount may change an aspirational negative space amount in a corresponding manner. For example, increasing the aspirational credit amount may decrease the aspirational negative space amount, and decreasing the aspirational credit amount may increase the aspirational negative space amount.

In some embodiments, the system may determine and suggest an aspirational credit amount. The suggested aspirational credit amount may be determined based on one or more factors such as the user's current or past financial health or behaviors, the user's previous payment amount(s), the user's financial budget, etc. For example, the suggested aspirational credit amount may be less than the user's previous purchase amount or monthly budget. In this manner, the system may prevent or deter the user from spending more than the user can afford.

In some embodiments, the suggested aspirational credit amount may be based on the user's future financial health, such as the user's current, aspirational, or predicted credit score. For example, the suggested aspirational credit amount may be determined based on a prediction of the user's credit score. The system may determine that a certain credit amount may result in improving the user's credit score.

Embodiments of the disclosure may include determining a “smart spot” payment amount and displaying the smart spot information using a financial oculus. The smart spot payment amount may be another type of goal, personalized for the user. FIGS. 5A-5C illustrate an exemplary payments UI showing a smart spot payment amount, according to embodiments of the disclosure.

The UI 500 shown in FIG. 5A illustrates an exemplary initial payments UI. The payments UI may display a financial oculus 510. The financial oculus 510 may provide balance information using the credit oculus visualization 506A and statement information using the statement oculus visualization 506C. In the example shown in the figure, the statement balance is $700, and current account balance is $900.

The financial oculus 510 may also display a minimum payment amount of $70, represented by the minimum payment oculus visualization 506E. The financial oculus 510 may include a smart spot payment oculus visualization 506F. From the payments UI, the user can determine that the smart spot payment amount is greater than the minimum payment amount and less than the statement balance based on the size of the smart spot payment oculus visualization 506F relative to the minimum payment oculus visualization 506E and the statement oculus visualization 506C.

The payments UI 500 may include a payment visualization 504 and a payment amount text 512 (representative of a payment amount). While the payment amount is displayed, the UI 500 may receive user input. For example, the user may move the position of the payment visualization 504 using a finger. In response to the user input, the payment amount shown in the payment amount text 512 may change according to the user input. For example, as shown in FIG. 5A, the payment amount text 512 may display $000.00 as a payment amount when the payment visualization 504 is located at the bottom of the financial oculus 510.

When the user moves the location of the payment visualization 504 to the top of the minimum payment oculus visualization 506E, the payments UI 500 displays the minimum payment amount in the payment amount text 512, as shown in FIG. 5B. The payments UI 500 may include a payment duration text 514, which presents a suggestion regarding the total time and total amount paid if the user chooses to pay the payment amount shown in the payment amount text 512. In the example shown, if the user makes a payment of the minimum payment amount of $70.00, the total time to pay the statement balance would be five (5) years, and the total amount paid would be $1,750.

When the user moves the location of the payment visualization 504 to the top of the smart spot payment oculus visualization 506F, the payments UI 500 displays the smart spot payment amount (e.g., $90.00) in the payment amount text 512, as shown in FIG. 5C. The payment amount text 512 and the payment duration text 514 may change to reflect the smart spot payment amount and corresponding total time and total amount paid if the user chooses to pay the smart spot payment amount. In the example shown, if the user makes a payment of the smart spot payment amount of $90.00, the total time to pay the statement balance would be reduced to four (4) years, and the total amount paid would decrease to $1,250. In this manner, the user may move the location of the payment visualization 504 to view different payment options and financial information associated with one or more scenarios.

The smart spot payment amount may be based on the user's past payment(s) and/or spending behaviors. In some embodiments, the smart spot payment amount may be determined using the user's recent spending activity, the balance due on the account, etc. For example, the smart spot payment amount can be greater than the user's recent spending activity, average spending amount, etc. to ensure that the balance due decreases over time. In some embodiments, the smart spot payment amount may be greater than the amount needed to pay off the balance in three years, if applicable. Additionally or alternatively, the smart spot payment amount may be greater than or equal to an amount determined from one or more past payment amounts, such as the average past payment amount, the maximum past payment amount, etc.

In some embodiments, the payment amount text may not be located within the financial oculus, as shown in the examples of FIGS. 5D-5G. The UI 501 may comprise a financial oculus 511 and a payment amount text 513. The payment amount text 513 may display an amount that corresponds to one or more highlighted (e.g., in blue-colored sphere) visualizations of the financial oculus 511. For example, as shown in the example of FIG. 5D, the payment amount entered in the payment amount text 513 is $50.00, which corresponds to the minimum amount due as shown by the highlighted, minimum payment oculus visualization 507E.

The user may move the location of the aspiration visualization 505 to be proximate to another visualization, such as the smart spot visualization 507F, as shown in FIG. 5E. In response to the user input of moving the location of the aspiration visualization 505, the payment amount text 513 may update to reflect the smart spot amount of $70.00. Additionally, in response to the user input, the highlighted visualization of the financial oculus 511 may change according to the user input, corresponding to the new location of the aspiration visualization 505 (e.g., smart spot visualization 507F). In some embodiments, the user interaction may also cause one or more visualizations, such as the minimum payment oculus visualization 507F (of FIG. 5D), to be removed from the UI 501.

FIGS. 5F and 5G illustrate payment UIs 509 and 511, which have been updated in accordance with the user's movement of the location of the aspiration visualization 505 to the statement visualization 507C and the credit visualization 506A, respectively. In some embodiments, as shown in the figures (FIGS. 5D-5G), portions of the UI may be updated in response to the user interaction including, but not limited to, the financial oculus, the minimum payment visualization, the smart spot payment visualization, the statement visualization, and the credit visualization. Additionally or alternatively, the payment duration text 515 may be updated. For example, in UI 501 (of FIG. 5D), the payment duration text 515 may display the amount of time to pay the statement balance (e.g., 5 years) and total interest paid (e.g., $1,750.00) when paying the minimum payment amount due. In FIG. 5E, the payment duration text (e.g., payment duration text 515 of UI 503, shown in FIG. 5E) may provide the total amount saved by paying the smart spot amount, greater than the minimum payment amount due. In FIG. 5F, the payment duration text 515 of UI 509 may inform the user that he or she will not payment any interest as a result of paying the statement balance, and this may improve his or her credit score. The payment duration text 515 may further inform the user that he or she will have access to the full line of credit, as shown in UI 511 of FIG. 5G.

FIG. 5H illustrates a flow chart of an exemplary method 521 for determining a smart spot payment amount, according to embodiments of the disclosure. In step 523, the system may review the payment history (e.g., payment amount history) for the user. In step 525, the system may perform payment segmentation analysis to determine a segmentation value. The segmentation analysis may involve determining one or more suggestions for improving the user's financial health.

In step 527, the system may apply the segmentation. In some embodiments, the segmentation may comprise using a machine-learning model trained to receive one or more properties related to the user as input and provide personalized recommendations. The personalized recommendations may be based on seasonality, historical spend, and current spend, or other factors specific to the user. In some embodiments, a machine-learning or artificial intelligence model may continually adapt the suggestions specific to the user over time. The personalized recommendations may be tailored to specific users, for example.

In step 529, the system may determine the average monthly activity (e.g., identify the user's average monthly spending). In some embodiments, a machine-learning or artificial intelligence model may be used to provide personalized recommendations based on, e.g., seasonality, historical spend, current spend, or other factors specific to the user.

In step 531, the system may determine a payoff amount. The payoff amount may be determined based on a predetermined payoff time, such as three years. In some embodiments, the payoff amount may be based on the statement balance/value and the average monthly activity. The system then determines if the payoff amount is greater than or equal to the segmentation value (step 533). If the user wants to pay the statement balance in full, then the smart spot amount is not displayed (step 537).

If the payoff amount is less than the segmentation value, then the smart spot amount may be set equal to the payoff amount (step 535). If the payoff amount is greater than or equal to the smart spot amount, then the system determines the current payoff time frame (step 539). The current payoff time frame may be the duration it would take to pay off the statement value using the payoff amount.

In step 541, the system may determine the additional amount needed to reduce the time frame by a predetermined reduction payoff time, such as six months. In step 543, the system may add the additional amount to the segmentation value. The smart spot amount may be set equal to the segmentation value (step 545).

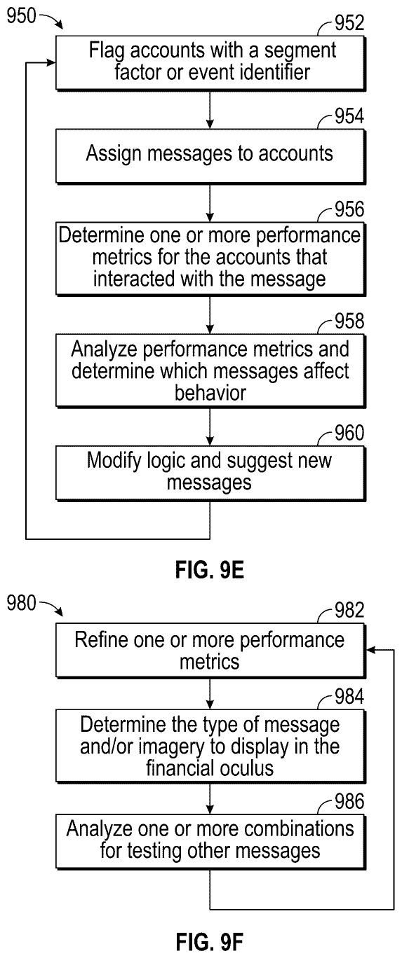

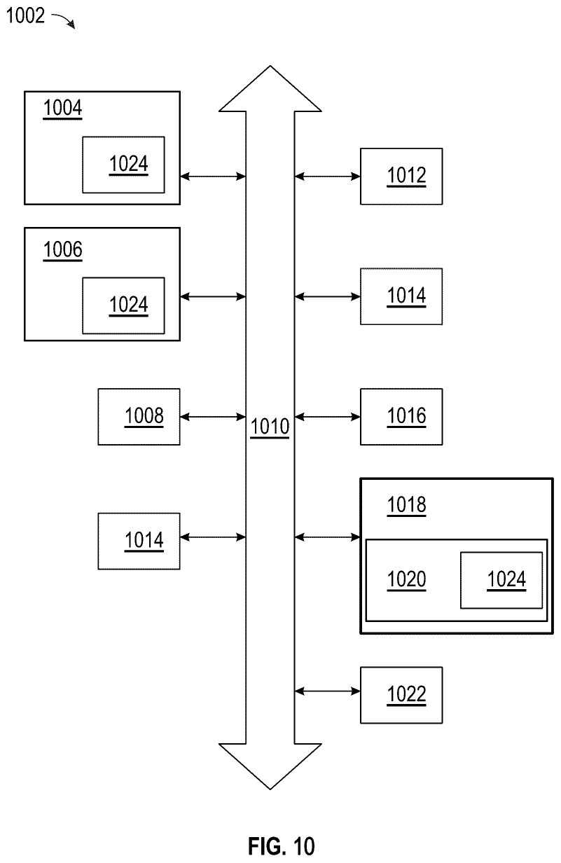

Embodiments of the disclosure may include providing suggestions to improve the user's credit score. FIG. 51 illustrates a flow chart of an exemplary method 547 for determining a smart spot payment amount for improving a user's credit score, according to embodiments of the disclosure. In step 549, the system may determine the user's credit amount. In step 551, the system may determine the statement value. In step 553, the system may calculate the current utilization. In step 555, the system may determine whether the current utilization is above a first threshold, between first and second thresholds, or below the second threshold. In some embodiments, machine learning or artificial intelligence may be used to determine one or more thresholds specific to the user. The thresholds may be based on seasonality, historical and current spending, or other factors specific to the user. As non-limiting examples, the first threshold may be 50%, and the second threshold may be 30%.

If the current utilization is above the first threshold, then the system may determine the payment amount needed to meet the first threshold (step 561). This payment amount may be set as the smart spot payment amount (step 559). If the current utilization is between the first and second thresholds, then the system may determine the payment amount needed to establish the second threshold (step 557). This payment amount may be set as the smart spot payment amount (step 559). If the current utilization is below the second threshold, then the system may not determine a smart spot payment amount (step 563).

Embodiments of the disclosure may include providing suggestions regarding the user's budget strategy. FIG. 5J illustrates a flow chart of an exemplary method 565 for determining a budget strategy, according to embodiments of the disclosure. In step 567, the system may determine the user's credit amount. In step 569, the system may determine the statement value. In step 571, the system may calculate the current utilization. In step 573, the system may determine whether the current utilization is above a first threshold, between first and second thresholds, between second and third thresholds, or below the third threshold. In some embodiments, machine learning or artificial intelligence may be used to determine one or more thresholds specific to the user. The thresholds may be based on seasonality, historical and current spending, or other factors specific to the user. As non-limiting examples, the first threshold may be 50% utilization, the second threshold may be 30% utilization, and the third threshold may be 10% utilization.

If the current utilization is above the first threshold, then the system may determine the payment amount and the spend reduction needed to establish the first threshold (steps 575 and 576). This spend reduction may be the suggested amount that the budget should be reduced and may be presented as part of the budget strategy (step 581).

If the current utilization is between the first and second thresholds, then the system may determine the payment amount and spend reduction needed to establish the second threshold (steps 577 and 578). This spend reduction may be presented as part of the budget strategy (step 581).

If the current utilization is between the second and third thresholds, then the system may determine the payment amount and spend reduction needed to establish the third threshold (steps 579 and 580). This spend reduction may be presented as part of the budget strategy (step 581).

If the current utilization is below the third threshold, then the system may not provide a suggestion (step 583). In step 585, the system may determine whether a certain utilization goal has been achieved. If so, the process repeats starting at step 567. If not, the system continues to present strategies, in step 587.

Although the above discusses the smart spot payment amount as a value determined by the system (e.g., based on a payment amount needed to meet a threshold hold, or a payment amount determined based on segmentation value or credit utilization), embodiments of the disclosure may include a smart spot payment amount that may be set and/or changed by the user.

FIG. 6A illustrates an exemplary initial dashboard UI, according to embodiments of the disclosure. The dashboard UI 600 may include a plurality of visualizations. The layout and level of detail may present information to a user in a simple, but comprehensive format.

The payment visualization 602A may provide payment information, such as the minimum payment amount, when the next payment is due, and an auto pay payment GUI button. The recent activity visualization 602B may provide detailed recent activity information.

The financial oculus 610 may provide balance information using one or more visualizations, as discussed in more detail above. The financial oculus 610 may provide a summary of the user's line of credit, current balance, statement balance, and minimum payment due using one or more visualizations (e.g., circles or spheres). By providing a summary on the initial dashboard UI, the information presented to the user may be simple, but comprehensive. In this manner, the user is less likely to miss critical payment and balance information.

In some embodiments, the financial oculus 610 may be a GUI button that when clicked (e.g., tapped, pressed, held down, etc.) may result in displaying a larger financial oculus 610 having more detailed information (such as shown in FIG. 6B). The text 606 may provide information corresponding to the financial oculus 610.

In some embodiments, the financial app may provide information about multiple accounts to the user. The account visualization 616 may allow a user to switch UIs associated with different accounts.

The dashboard UI may also provide other information to the user in the information visualization 618. Exemplary information may include, but are not limited to, the number of credit points and the user's credit score.

Embodiments of the disclosure include allowing the user to set goals related to the financial metrics. FIGS. 7A-7D illustrate exemplary goal setting UIs, according to embodiments of the disclosure. In some embodiments, the goal setting UIs may be displayed the first time the user uses the app. The UI 701 in FIG. 7A may display a welcome screen. The welcome screen may inform the user of a quiz for goal setting (e.g., with text box 718 displaying (“Your credit goals are important to us. Take a minute to answer two questions, so we can customize your experience and turn those goals into successes!”). In some embodiments, the user may bypass the goal setting option by clicking on the UI button 720.

If the user clicks on the UI button 722, the system may direct the user to the UIs 703 and 705, displaying the first and second questions of the quiz, as shown in FIGS. 7B and 7C, respectively. The questions may prompt the user to select his or her number one goal and the past behavior that impacted the user's credit the most. The system may receive the answers and use them to make sure the user makes progress towards the user-selected goal. In some embodiments, the system may provide messages to the user indicating deviation away from (e.g., such as when the user's behavior strays from a path of the selected goal or resembles the past behavior) a financial goal or towards a financial goal.

In some embodiments, the system may check in with the user at periodic intervals (e.g., every six months) to determine whether the user's goals have changed. An exemplary UI 707 showing the periodic check-in is provided in FIG. 7D. The check-in UI 707 may display the user's current goal and may allow the user to change the user's goal or continue with the same goal.

In some embodiments, the system may provide the option to pay the current balance (total payment amount) in one or more payments. FIG. 8A illustrates a split-payment frequency UI 801 displaying a plurality of split-payment options to the user, according to embodiments of the disclosure. The system may allow the user to split the total payment amount into multiple payment amounts, which may be paid at different time periods. The UI 801 may allow the user to visualize information for multiple options on the same display screen via a split-payment visualization. For example, if the current balance is $70.00, the split-payment visualization may provide a plurality of split-payment options visualizations 802: the first split-payment option visualization 802A may be one payment of $70.00, the second split-payment option visualization 802B may be two payments of $35.00 each, the third split-payment option visualization 802C may be three payments of $23.50 each, and the fourth split-payment option visualization 802D may be four payments of $17.50 each. The split-payment visualization may provide the user with a simply way to visualize what each split-payment option entails with respect to the number of payments and the amount for each payment.

After the system receives user input on one of the split-payment option visualizations (selecting a split-payment option), the system may display UI 803 showing a calendar, which allows the user to pick when to make the one or more payments. The user may click on one or more calendar dates for a given month displayed with the calendar visualization 811 or may select one or more calendar dates for a different month (e.g., using one of the GUI buttons 813). Selecting a different month may cause the system to display a different calendar as the calendar visualization. The user has the flexibility to pre-pick and/or pre-schedule payment dates that most align with the user's preferences and schedule on the calendar visualization. After the user makes selection(s), the system may display a summary of the selection(s) on UI 805 of FIG. 8C and a confirmation on UI 807 of FIG. 8D. In some embodiments, the user may click on a calendar GUI button 809, which may cause the system to create one or more reminders on the user's device (e.g., a smartphone, a laptop, etc.). The one or more reminders may correspond to the date(s) the user selected on the calendar visualization. By adding the selected date(s), the user may be reminded by the user device to make payments.

Additionally or alternatively, the system may provide the user with personalized messages. For example, as shown in FIGS. 9A-9D, the system may display messages that provide tips or strategies to the help the user make informed decisions. In some embodiments, the messages may be presented in real-time. In some embodiments, the information in the message or the type of message may be generated, selected, and/or displayed in real-time based on the user's interaction with the system. The message information and/or type may be generated or selected by a trained machine-learning model based on one or more factors, such as the user's behavior, goals, overall financial health, etc.

For example, if the user has been frequently making (e.g., reached a threshold number of) late payments, the machine-learning model may decide that enrolling the user in auto pay may help improve the user's financial behavior. The machine-learning model may select an auto pay message. An exemplary auto pay message 901 is shown in FIG. 9A. As another example, if the user's goal is to have a certain amount of credit available, the machine-learning model may select a decline risk message 903 to be displayed, as shown in FIG. 9B, or a cushion message 905 to be displayed, as shown in FIG. 9C. The messages may encourage the user to make an additional payment to bring down the user's utilization. For example, a message encouraging the user to make an additional payment may be generated or selected and displayed when the user's goal is improve credit and the user's credit utilization (e.g., 80%) is below a threshold credit utilization (e.g., 50%).

Unlike conventional systems, these messages may be more interactive, providing personalized explanations to the user and encouraging the user to engage in positive financial behaviors (or discouraging the user from engaging in negative financial behaviors). Although FIGS. 9A-9C show messages that are displayed when the user initially opens the app, embodiments of the disclosure may include generating, selecting, and/or displaying the messages at any time. In some embodiments, the system may generate or select and display a message while the user is navigating the app, such as when looking at the financial oculus. The message may be overlaid on top of another UI, for example, as shown in FIG. 9D. The message 907 may provide the user with a status update (e.g., “You've used <XX%>of your credit line”) and one or more related strategies (e.g., “Keeping your balance below 50% of your credit line, can help you build better credit.”).

FIGS. 9E and 9F illustrate flow charts of exemplary methods for generating or selecting a personalized message, according to embodiments of the disclosure. Method 950 of FIG. 9E may comprise a method where the system tests certain messages and learns which messages affect user behavior. In some embodiments, method 950 may be used for initial setup of the personalized messaging system.

Method 950 may begin with step 952 where the system flags the accounts that have a segment factor or event identifier (e.g., recent-trigger-event identifier). Exemplary segment factors may include timing, frequency, and amount associated with user payment behavior. For example, the system may flag those accounts where the user made a threshold number of late payments. In some embodiments, a recent-trigger-event identifier may indicate certain recent events that may warrant messaging the user. For example, a recent trigger event may include shifts in utilization rate, balance building, or certain types of transactions. In some embodiments, an account may be associated with a recent-trigger-event identifier when the system determines recent events are of a certain risk level or involve a certain level of product engagement.

In step 954, the system may assign a message to an account based on the segment factor and/or event identifier. In some embodiments, the message may be a preselected message. The preselected message may include message information (e.g., language) that has already been approved. In some embodiments, the assigned message may be randomly or pseudo-randomly selected. In some embodiments, step 954 may comprise assigning a control group (e.g., including a select group of accounts) for holdout.

In step 956, the system may determine one or more performance metrics of the accounts associated with a user that interacted with the message. The performance metrics may indicate the type and/or level of user interaction, such that the system may determine which messages affect user behavior (and/or which messages do not affect user behavior) based on an analysis of the performance metrics (in step 958). As one non-limiting example, if a message suggests that the user make an additional payment (e.g., such as message 903 of FIG. 9B), and the user makes an additional payment shortly after receiving the message, the system may determine that the message positively affected the user's behavior, and a performance metric may indicate such positive influence. In some embodiments, the performance metrics may be key performance indicators. Exemplary key performance indicators may include, but are not limited to, payment rate, percentage of payment compared to minimum payment amount due, a delinquency rate (e.g., 30-day delinquency rate), charge off rate, credit line increase rate, and credit score shift.

In step 960, the system may modify the logic and/or message based on the analysis in step 958. Additionally or alternatively, the system may suggest one or more new messages based on the analysis in step 958. Method 950 may be repeated until the system has learned which messages affect or do not affect user behavior and/or the system has tested the messages on certain types of accounts (e.g., based on segment factors, event identifiers, or the like). In some embodiments, the steps of method 950 are repeated for a predetermined period of time (e.g., 4-6 months) or until a predetermined amount of data has been gathered. The gathered data may be used by the method 980 of FIG. 9F. Exemplary data may include segment factors and trigger events.

Method 980 of FIG. 9F may comprise a method for refining message combinations, including personalizing the messages to a given user and associated account. In step 982, a machine-learning model may be configured to refine one or more performance metrics. The machine-learning model may review the exemplary data from method 950, and in some embodiments, use additional variables, to improve the performance metrics. The refinement process may include refining the probability that the performance metrics will be achieved.

In step 984, the machine-learning model may determine a message combination (e.g., the type of message (including the message information and phrasing) and/or imagery) to be displayed in the financial oculus. The message combination selected in step 984 may be the most optimal combination, having the highest performance metric(s).

In step 986, the message combinations may be analyzed to select those that have low-performance metrics. The low-performance message combinations may be modified, e.g., to include different message information, phrasing, and/or imagery. In some embodiments, the modified low-performance message combinations may be tested and refined. Low-performance message combinations may be those message combinations having a performance metric lower than a threshold.

As one non-limiting example, the machine-learning model may determine first performance metric(s) associated with a first message combination. For example, there may be a first probability (e.g., 60%) that users having first attributes (associated with segment factors and/or event identifiers) will pay their bills on time. The first message combination may be a payment reminder message sent five days before the payment due date. The machine-learning model may test a second message combination and determine whether this second message combination has higher performance metric(s), in this example, a second probability. An example second message combination may be a payment reminder message sent 10 days before the payment due date.

If the second probability is lower compared to the first probability, the system may modify the second message combination and determine whether third message combination (modified second message combination) has a higher third probability than the first and/or second probabilities. In some embodiments, the machine-learning model may form new message combination(s) based on the same attribute of the first message. For example, the new message combination may be based on the number of days before the payment due date. In some embodiments, the machine-learning model may form new message combination(s) based on additional attributes (e.g., payment amount) of the first message. The machine-learning model may continue to refine the message combinations until one or more criteria for the performance metrics has been achieved. For example, the machine-learning model may continue to refine the message combinations until the probability is as close to 100% (e.g., greater than a threshold probability such as 90%).

FIG. 10 illustrates a block diagram of an exemplary system 1002, according to embodiments of the disclosure. The system may be a machine such as a computer, within which a set of instructions, causes the machine to perform any one of the steps and processes discussed herein, according to embodiments of the disclosure. In some embodiments, the machine can operate as a standalone device or may be connected (e.g., networked) to other machines. In a networked configuration, the machine may operate in the capacity of a server or a client machine in a server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, a switch or bridge, or any machine capable of executing a set of instructions (sequential or otherwise) that specify actions to be taken by that machine. A mobile device such as a PDA or a cellular phone may also include an antenna, a chip for sending and receiving radio frequency transmissions and communicating over cellular phone WAP and SMS networks, and a built-in keyboard. Further, while only a single machine is illustrated, the term “machine” shall also be taken to include any collection of machines that individually or jointly execute a set (or multiple sets) of instructions to perform any one of the methodologies discussed herein.

The exemplary computer 1002 includes a processor 1004 (e.g., a central processing unit (CPU), a graphics processing unit (GPU), or both), a main memory 1006 (e.g., read-only memory (ROM), flash memory, dynamic random access memory (DRAM) such as synchronous DRAM (SDRAM) or Rambus DRAM (RDRAM), etc.), and a static memory 1008 (e.g., flash memory, static random access memory (SRAM), etc.), which can communicate with each other via a bus 1010.

The computer 1002 may further include a video display 1012 (e.g., a liquid crystal display (LCD) or a cathode ray tube (CRT)). The computer 1002 also includes an alpha-numeric input device 1014 (e.g., a keyboard), a cursor control device 1016 (e.g., a mouse), a disk drive unit 1018, a signal generation device (e.g., a speaker), and a network interface device 1022.

The drive unit 1018 includes a machine-readable medium 1020 on which is stored one or more sets of instructions 1024 (e.g., software) embodying any one or more of the methodologies or functions described herein. The software may also reside, completely or at least partially, within the main memory 1006 and/or within the processor 1004 during execution thereof by the computer 1002, the main memory 1006 and the processor 1004 also constituting machine-readable media. The software may further be transmitted or received over a network 804 via the network interface device 922.

While the machine-readable medium 1020 is shown in an exemplary embodiment to be a single medium, the term “non-transitory computer-readable medium” should be taken to include a single medium or multiple media (e.g., a centralized or distributed database and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A computer-implemented method for providing suggestions to improve a user's financial health, the computer-implemented method comprising:
determining one or more metrics indicative of the user's financial health, wherein the one or more metrics are determined based on the user's current or past financial health or behaviors;
receiving input from the user that sets or makes adjustments to one or more user-selected financial goals;
determining one or more relationships between the one or more metrics and the one or more user-selected financial goals; and
determining and displaying one or more messages providing the suggestions to the user on a graphical user interface, wherein the one or more messages are associated with the one or more metrics, the one or more financial goals, or the one or more relationships.

2. The method of claim 1, wherein:
the one or more metrics include one or more of: the user's credit card health, credit score, debt-to-income ratio, safety spending zone, payment amount history, average monthly activity value, statement value, activity value, or credit amount; or
the one or more user-selected financial goals include one or more of: having the ability to pay, paying down a balance, reducing total amount paid, reducing time until a debt is paid, improving credit score, lowering credit utilization, or achieving an aspirational credit amount.

3. The method of claim 1, wherein the one or more messages comprise a message including the one or more metrics, a message including the one or more user-selected financial goals, a message including a smart spot payment amount, a message indicating deviation away from or towards the one or more user-selected financial goals, or a personalized message providing tips or strategies.

4. The method of claim 1, further comprising:
determining a user's current utilization;
comparing the current utilization and one or more thresholds; and
determining a smart spot payment amount based on the comparison of the current utilization and the one or more thresholds,
wherein the one or more messages comprise a messaging include the smart spot payment amount.

5. The method of claim 4, wherein the one or more thresholds are determined using a machine-learning model and based on seasonality, historical and current spending, or a combination thereof.

6. The method of claim 1, further comprising:
using a machine-learning model to determine a segmentation value;
determining a pay off amount based on a statement balance and average monthly activity of the user;
comparing the pay off amount and the segmentation value; and
determining a smart spot payment amount based on the comparison of the pay off amount and the segmentation value,
wherein the one or more messages comprise a message including the smart spot payment amount.

7. The method of claim 1, further comprising:
displaying a financial oculus comprising one or more visualizations, wherein one or more properties of the one or more visualizations are indicative of or related to the one or more metrics or the one or more user-selected financial goals.

8. The method of claim 7, further comprising:
receiving input from the user that adjusts the one or more properties of the one or more visualizations.

9. The method of claim 1, further comprising:
displaying a countdown visualization, wherein one or more properties of the countdown visualization are indicative of an urgency of a payment due.

10. The method of claim 1, further comprising:
displaying a financial oculus on the graphical user interface;
displaying, within the financial oculus, a plurality of visualizations corresponding to the one or more metrics, wherein the plurality of visualizations includes:
a statement oculus visualization indicating a statement value,
an activity oculus visualization indicative an activity value, and
a credit oculus visualization indicative a credit amount; and
updating one or more properties of the plurality of visualizations when the statement value, the activity value, or the credit amount changes.

11. The method of claim 1, further comprising:
selecting a personalized message based on the user's current or past financial health or behaviors and the one or more user-selected financial goals, wherein the one or more messages displayed to the user comprises the personalized message.

12. The method of claim 11, wherein selecting the personalized message is performed in response to a risk-related recent trigger event.

13. The method of claim 12, wherein the risk-related recent trigger event comprises one or more of: a threshold number of late payments made, a shift in utilization rate, a shift in balance building, meeting a certain risk level, or meeting a certain level of product engagement.

14. The method of claim 11, wherein the selected personalized message is a message related to encouraging the user to engage in positive financial behaviors.

15. The method of claim 11, wherein the selected personalized message is a message related to discouraging the user from engaging in negative financial behaviors.

16. The method of claim 1, further comprising:
selecting a personalized message based on the user's interaction with the graphical user interface, wherein the one or more messages displayed to the user comprises the personalized message.

17. The method of claim 16, further comprising:
determining one or more performance metrics associated with the user's interaction with the graphical user interface in response to the displaying the one or more messages,
wherein the personalized message is selected based on the one or more performance metrics.

18. The method of claim 17, further comprising:
creating a new message or modifying the one or more messages based on the one or more performance metrics.

19. The method of claim 1, further comprising:
periodically checking whether the one or more user-selected financial goals have changed; and
allowing the user to change or maintain the one or more user-selected financial goals.

20. The method of claim 1, wherein a machine-learning model determines the one or more messages based on the user's current or past financial health or behaviors.
